(19) United States
(12) Patent Application Publication
(10) Pub. No.: US 2017/0293961 A1
(43) Pub. Date: Oct. 12, 2017

(54) EXHIBITION INFORMATION PRESENTATION METHOD AND SYSTEM

(71) Applicant: Alibaba Group Holding Limited, Grand Cayman (KY)

(72) Inventor: Chong Shing Cheung, Hangzhou (CN)

(21) Appl. No.: 15/480,130

(22) Filed: Apr. 5, 2017

(30) Foreign Application Priority Data
Apr. 6, 2016 (CN) 201610210415.0

(51) Int. Cl. G06Q 30/06; G01C 21/36

(52) U.S. Cl. CPC G06Q 30/0625; G01C 21/3676; G01C 21/3682

(57) ABSTRACT

An exhibition information presentation method includes acquiring an exhibition information presentation activation operation inputted by a first user, the exhibition information presentation activation operation being associated with product information currently browsed or searched by a second user; and displaying exhibition information or an exhibition information link item corresponding to the product information at a preset first position, where the exhibition information link item is used for acquiring a link operation inputted by the first user to open a corresponding exhibition information presentation page. In this way, product presentation is combined with exhibition information presentation, and a user can instantly know information about an exhibition in which a product participates when browsing or searching for the product, thus expanding the coverage of exhibition information of the product, expanding a channel of communications between the user and a merchant, and improving the efficiency of communications between the user and the merchant.

### CROSS REFERENCE TO RELATED PATENT APPLICATION

This application claims foreign priority to Chinese Patent Application No. 201610210415.0 filed on Apr. 6, 2016, entitled “Exhibition Information Presentation Method and System”, which is hereby incorporated by reference in its entirety.

### TECHNICAL FIELD

The present disclosure relates to the field of software technologies, and in particular, to methods and systems for presenting exhibition information.

### BACKGROUND

Various offline exhibitions such as product trade fairs and expositions are good opportunities and platforms for merchants to promote their products. Compared with online virtualized information related to products and merchants, offline exhibitions are better for users to investigate physical products intuitively and to inquire and cooperate with merchants in person. Currently, from a user perspective, if a user wants to know exhibition information of products or merchants, the user needs to search the Internet or query professional exhibition institutions and cannot obtain related exhibition information immediately when they see a product. From a merchant perspective, exhibition information is separated from a product information platform. The product information platform (such as an e-commerce platform) has much greater traffic, and related exhibition information of products and merchants cannot be presented on the product information platform, thus resulting in a low coverage rate and a low immediacy of releasing exhibition information, and affecting product promotion and business cooperation.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

To overcome the problem of the separation of exhibition information from a product information platform in existing technologies, the present disclosure provides a method and a system of presenting exhibition information.

In implementations, the present disclosure provides a method for presenting exhibition information. The method may include acquiring an exhibition information presentation activation operation inputted by a user, the exhibition information presentation activation operation being associated with product information, and the product information being information about a product currently browsed or searched by the user; and displaying exhibition information or an exhibition information link item corresponding to the product information at a preset first position according to the exhibition information presentation activation operation.

In implementations, the method may further include acquiring exhibition registration information of the user; determining whether an exhibition registered by the user matches an exhibition in the exhibition information corresponding to the product information based on the exhibition registration information; and displaying a prompt dialog box in response to the exhibition registered by the user matching the exhibition information corresponding to the product information.

In implementations, the method may further include acquiring current location information of the user; determining whether the user is located in the exhibition registered by the user based on the current location information; and displaying a location of the product in the exhibition if the user is located in the exhibition registered by the user.

In implementations, the method may further include querying an exhibition time corresponding to product information collected or followed by the user; calculating a time difference between the exhibition time and a current time; determining whether the time difference is less than or equal to a preset threshold; and sending a prompt message to the user if the time difference is less than or equal to the preset threshold, the prompt message being used for prompting the user with exhibition information corresponding to the collected or followed product information.

In implementations, the method may further include acquiring exhibition registration information of the user when the product information is information about a product currently searched by the user; querying preferred product information, exhibition information corresponding to the preferred product information being consistent with the exhibition registration information; and preferentially displaying the preferred product information on a product search result page.

In implementations, the method may further include acquiring launch information of a new exhibition, the launch information including a product category that is exhibited; determining whether the product belongs to the product category based on the product information; determining whether the product has been participated in the new exhibition based on the exhibition information corresponding to the product information, if the product belongs to the product category; displaying a label indicating that the product has been participated in the new exhibition if the product has been participated in the new exhibition; and displaying a new exhibition recommendation message if the product is not participated in the new exhibition.

In implementations, the present disclosure provides another method for presenting exhibition information. The method may include acquiring exhibition information; determining a product category included in an exhibition based on the exhibition information; and presenting related exhibition information on a page of a product belonging to the product category.

In implementations, after the exhibition information is acquired and before the product category related to the exhibition is determined based on the exhibition information, the method may further include auditing the exhibition information; and determining the product category included in the exhibition based on the exhibition information, if the exhibition information passes the auditing.

In implementations, presenting the related exhibition information on the page of the product belonging to the product category may include presenting complete exhibition information on the page of the product belonging to the product category, or presenting a portion of the exhibition information that corresponds to the product on the page of the product belonging to the product category if the exhibition information includes multiple product categories.

In implementations, the present disclosure may further provide an exhibition navigation method. The method may include acquiring product information currently browsed by a user; determining whether a corresponding product is presented in an exhibition based on the product information; and displaying an exhibition map of the exhibition and displaying an exhibition location of the product on the exhibition map if the product is presented in the exhibition.

In implementations, the method may further include acquiring a current location of the user; displaying the current location of the user on the exhibition map; and displaying a route from the current location of the user to the exhibition location of the product.

In implementations, the present disclosure may further provide another exhibition navigation method. The method may include acquiring a current location of a user; comparing the current location of the user with geographical locations of individual exhibitions to determine whether the user is located in an exhibition; acquiring product information currently browsed by the user if the user is located in the exhibition; determining whether a corresponding product is presented in the exhibition where the user is located based on the product information; and displaying an exhibition location of the product on an exhibition map if the product is presented in the exhibition where the user is located.

In implementations, the method may further include displaying the current location of the user on the exhibition map; and displaying a route from the current location of the user to the exhibition location of the product.

In implementations, the present disclosure further provides an exhibition information presentation system. The system may include a presentation activation operation acquisition unit configured to acquire an exhibition information presentation activation operation inputted by a user, the exhibition information presentation activation operation being associated with product information, and the product information being information about a product currently browsed or searched by the user; and a first display unit configured to display exhibition information or an exhibition information link item corresponding to the product information at a preset first position according to the exhibition information presentation activation operation.

In implementations, the system may further include a first exhibition registration information acquisition unit configured to acquire exhibition registration information of the user; an exhibition information matching unit configured to determine whether an exhibition registered by the user matches an exhibition in the exhibition information corresponding to the product information based on the exhibition registration information; and a prompt display unit configured to display a prompt dialog box if the exhibition registered by the user matches the exhibition information corresponding to the product information.

In implementations, the system may further include a current user location acquisition unit configured to acquire current location information of the user; a location matching unit configured to determine whether the user is located in the exhibition registered by the user based on the current location information; and a product location display unit configured to display a location of the product in the exhibition if the user is located in the exhibition registered by the user.

In implementations, the system may further include an exhibition time query unit configured to query an exhibition time corresponding to product information collected or followed by the user; a launch time difference calculation unit configured to calculate a time difference between the exhibition time and a current time; a time difference determination unit configured to determine whether the time difference is less than or equal to a preset threshold; and a prompt message sending unit configured to send a prompt message to the user if the time difference is less than or equal to the preset threshold, the prompt message being used for prompting the user with exhibition information corresponding to the collected or followed product information.

In implementations, the system may further include a second exhibition registration information acquisition unit configured to acquire the exhibition registration information of the user when the product information is the information about the product currently searched for by the user; a preferred product information query unit configured to query preferred product information, exhibition information corresponding to the preferred product information being consistent with the exhibition registration information; and a preferred product information display unit configured to preferentially display the preferred product information on a product search result page.

In implementations, the system may further include a launch information acquisition unit configured to acquire launch information of a new exhibition, the launch information including a product category that is exhibited; a product category determination unit configured to determine whether the product belongs to the product category according to the product information; an exhibition participation determination unit configured to determine whether the product has been participated in the new exhibition based on the exhibition information corresponding to the product information, if the product belongs to the product category; an exhibition participation label display unit configured to display a label indicating that the product has been participated in the new exhibition if the product has been participated in the new exhibition; and an exhibition recommendation message display unit configured to display a new exhibition recommendation message if the product is not participated in the new exhibition.

In implementations, the present disclosure provides another exhibition information presentation system. The system may include an exhibition information acquisition unit configured to acquire exhibition information; a product category determination unit configured to determine a product category included in an exhibition based on the exhibition information; and a presentation unit configured to present related exhibition information on a page of a product belonging to the product category.

In implementations, the system may further include an audit unit configured to audit the exhibition information after the exhibition information is acquired and before the product category related to the exhibition is determined according to the exhibition information; the product category determination unit configured to determine the product category included in the exhibition based on the exhibition information, if the exhibition information passes the auditing.

In implementations, the presentation unit may further be configured to present complete exhibition information on the page of the product belonging to the product category, or, present a portion of the exhibition information that corresponds to the product on the page of the product belonging to the product category if the exhibition information includes multiple product categories.

In implementations, the present disclosure further provides an exhibition navigation apparatus. The apparatus may include a first product information acquisition unit configured to acquire product information currently browsed by a user; an exhibition determination unit configured to determine whether a corresponding product is presented in an exhibition based on the product information; and a location display unit configured to display an exhibition map of the exhibition and display an exhibition location of the product on the exhibition map if the product is presented in the exhibition.

In implementations, the apparatus may further include a user location acquisition unit configured to acquire a current location of the user; a user location display unit configured to display the current location of the user on the exhibition map; and a route display unit configured to display a route from the current location of the user to the exhibition location of the product.

In implementations, the present disclosure may further provide an exhibition navigation apparatus. The apparatus may include a user location acquisition unit configured to acquire a current location of a user; a first determination unit configured to compare the current location of the user with geographical locations of individual exhibitions to determine whether the user is located in an exhibition; a second product information acquisition unit configured to acquire product information currently browsed by the user if the user is located in the exhibition; a second determination unit configured to determine whether a corresponding product is presented in the exhibition where the user is located based on the product information; and an exhibition location display unit configured to display an exhibition location of the product on an exhibition map if the product is presented in the exhibition where the user is located.

In implementations, the apparatus may further include a user location display unit configured to display the current location of the user on the exhibition map; and a route display unit configured to display a route from the current location of the user to the exhibition location of the product.

In the technical solutions provided in the embodiments of the present disclosure, presentation of product information is combined with presentation of exhibition information. Corresponding exhibition information is presented at a position where product information is presented, so that, a user can instantly know information about an exhibition in which a product is participated when browsing or searching for this product, thus expanding the coverage of exhibition information of the product. This facilitates the user to acquire exhibition information of offline interaction with a merchant more efficiently and more timely, improving the number of customers for the merchant and promoting the product.

It should be noted that the above general description and the following detailed description are merely exemplary and illustrative, which do not limit the present disclosure.

### BRIEF DESCRIPTION OF THE DRAWINGS

In order to describe the technical solutions in the embodiments of the present disclosure or existing technologies more clearly, accompanying drawings needed for describing the embodiments or the existing technologies are introduced briefly herein. Apparently, one of ordinary skill in the art may obtain other drawings based on these accompanying drawings without making any creative effort.

FIG. 1 is a flowchart of an exhibition information presentation method according to an exemplary embodiment of the present disclosure.

FIG. 2 is an interface for setting product exhibition information.

FIG. 3 is an example of presentation of exhibition information.

FIG. 4 is another example of presentation of exhibition information.

FIG. 5 is a flowchart of another exhibition information presentation method according to an exemplary embodiment of the present disclosure.

FIG. 6 is a flowchart of another exhibition information presentation method according to an exemplary embodiment of the present disclosure.

FIG. 7 is a flowchart of another exhibition information presentation method according to an exemplary embodiment of the present disclosure.

FIG. 8 is a flowchart of another exhibition information presentation method according to an exemplary embodiment of the present disclosure.

FIG. 9 is a flowchart of another exhibition information presentation method according to an exemplary embodiment of the present disclosure.

FIG. 10 is a flowchart of another exhibition information presentation method according to an exemplary embodiment of the present disclosure.

FIG. 11 is a flowchart of another exhibition information presentation method according to an exemplary embodiment of the present disclosure.

FIG. 12 is a flowchart of an exhibition navigation method according to an exemplary embodiment of the present disclosure.

FIG. 13 is a flowchart of another exhibition navigation method according to an exemplary embodiment of the present disclosure.

FIG. 14 is a flowchart of another exhibition navigation method according to an exemplary embodiment of the present disclosure.

FIG. 15 is a flowchart of another exhibition navigation method according to an exemplary embodiment of the present disclosure.

FIG. 16 is a structural diagram of an exhibition information presentation system according to an exemplary embodiment of the present disclosure.

FIG. 17 is a structural diagram of another exhibition information presentation system according to an exemplary embodiment of the present disclosure.

FIG. 18 is a structural diagram of another exhibition information presentation system according to an exemplary embodiment of the present disclosure.

FIG. 19 is a structural diagram of another exhibition information presentation system according to an exemplary embodiment of the present disclosure.

FIG. 20 is a structural diagram of another exhibition information presentation system according to an exemplary embodiment of the present disclosure.

FIG. 21 is a structural diagram of another exhibition information presentation system according to an exemplary embodiment of the present disclosure.

FIG. 22 is a structural diagram of another exhibition information presentation system according to an exemplary embodiment of the present disclosure.

FIG. 23 is a structural diagram of another exhibition information presentation system according to an exemplary embodiment of the present disclosure.

FIG. 24 is a structural diagram of an exhibition navigation apparatus according to an exemplary embodiment of the present disclosure.

FIG. 25 is a structural diagram of another exhibition navigation apparatus according to an exemplary embodiment of the present disclosure.

FIG. 26 is a structural diagram of another exhibition navigation apparatus according to an exemplary embodiment of the present disclosure.

FIG. 27 is a structural diagram of another exhibition navigation apparatus according to an exemplary embodiment of the present disclosure.

FIG. 28 is a structural diagram of the example system or apparatus as described in FIGS. 16-27 in more detail.

### DETAILED DESCRIPTION

The exemplary embodiments are described in detail herein, and examples thereof are expressed in the drawings. When the drawings are involved in the description herein, identical numbers in different drawings represent identical or similar elements unless specified otherwise. Implementations described in the following exemplary embodiments do not represent all implementations that are consistent with the present disclosure. Rather, they are merely examples of systems and methods that are consistent with some aspects of the present disclosure described in detail in the appended claims.

For comprehensive understanding of the present disclosure, many exemplary details are mentioned in the following detailed description. However, one skilled in the art should understand that the present disclosure can be implemented without these exemplary details. In other embodiments, well-known methods, processes, components, and circuits are not described in detail to avoid unnecessary obscuring of the embodiments.

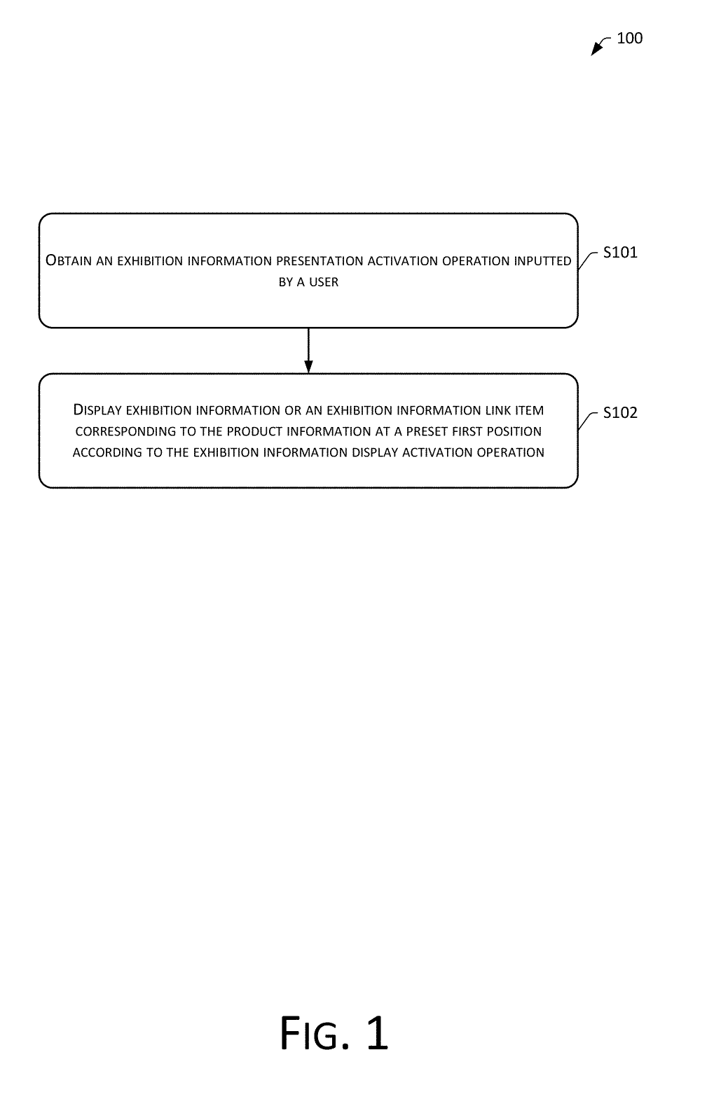

FIG. 1 is a flowchart of an exhibition information presentation method 100 according to an exemplary embodiment of the present disclosure. As shown in FIG. 1, the method 100 may include the following operations.

S101 obtains an exhibition information presentation activation operation inputted by a user, the exhibition information presentation activation operation being related to product information, and the product information being information about a product currently browsed or searched by the user.

In implementations, an exhibition information presentation activation operation UI (i.e., a user interface) is set up on a product information platform. The exhibition information presentation activation operation UI corresponds to product information, and the UI may be placed on a product browsing page or a product search page. The product browsing page may be an individual product information page or a merchant product information page. An individual product information page displays information of a product, and only one exhibition information presentation activation operation UI needs to be set up. A merchant product information page displays information about a merchant, information about products of the merchant, or information about the merchant and the products. Since it is actually the merchant that participates in an exhibition, and the products of the merchant generally participate in the same exhibition. Therefore, one exhibition information presentation activation operation UI may be set up on the merchant product information page, and a user can obtain overall exhibition information of the merchant by operating the UI. Alternatively, an individual exhibition information presentation activation operation UI may be set up for each product, especially when different products of a merchant are located in different exhibition areas of an exhibition. A user may obtain specific exhibition information of each product through an exhibition information presentation activation operation UI corresponding to the respective product. The exhibition information presentation activation operation UI may also be on the product search page. In an application scenario, the exhibition information presentation activation operation UI may be displayed on a product search result page after a product search is completed, and may correspond to each product. The exhibition information presentation activation operation UI corresponding to each product may be set beside each product item. In this way, when browsing a product search result, the user may also view exhibition information of a product through a respective exhibition information presentation activation operation UI corresponding to each product. In another application scenario, a search box may serve as an exhibition information presentation activation operation UI. A user operation of confirming a search after entering a product to be searched for may also be an exhibition information presentation activation operation. A system searches for the product according to the operation, displays search results, and presents exhibition information corresponding to each search result on a search result page. When the user performs the exhibition information presentation activation operation, the operation is performed for exhibition information of each product. As the exhibition information presentation activation operation UI corresponds to the product information, the exhibition information presentation activation operation is associated with the product information.

The exhibition information presentation activation operation UI may be a button, a checkbox, or the like. By checking a mark beside a checkbox of whether to display exhibition information, or clicking or pressing on a button by a user, an exhibition information presentation function is activated. Alternatively, if the user checks the checkbox, the exhibition information is displayed.

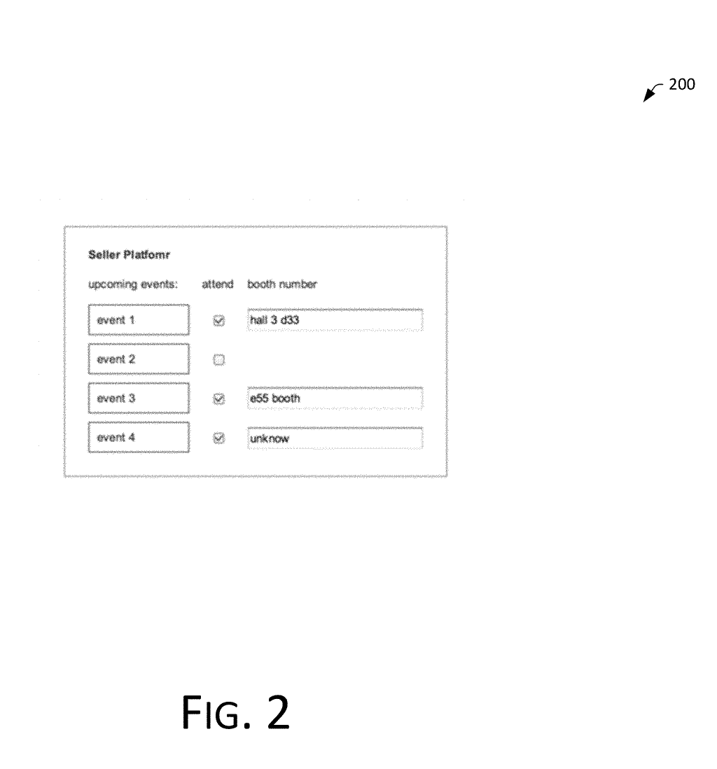

It should be noted that exhibition information corresponding to product information is configured in advance. FIG. 2 is an interface 200 for setting product exhibition information. A merchant may set presentation information of a product when uploading or editing information of the product. As shown in FIG. 2, events 1-4 are upcoming exhibitions. If the product is to be presented in an exhibition, an attend check bar is checked, and a specific location in the exhibition is inputted. For example, “hall 3, d33” (the third hall, booth 33), “e55 booth” (booth No. 55), etc., may be inputted in a booth number input box as shown in FIG. 2. If a location in the exhibition is undetermined, “unknown” may be inputted. Exhibition information corresponding to product information may be set up by designing a related setting interface according to requirements.

S102 displays exhibition information or an exhibition information link item corresponding to the product information at a preset first position according to the exhibition information display activation operation.

In implementations, the exhibition information link item may be used for acquiring a link operation inputted by the user, and a corresponding exhibition information presentation page may be opened according to the link operation. The first position is set in advance. In an application scenario, the first position may be an exhibition information presentation position reserved on an original product browsing page, or may be an exhibition information presentation position corresponding to each piece of product information on an original product search page. The first position may be set according to a requirement of design of the product browsing or search page. In another application scenario, the first position is a preset exhibition information presentation position on a popup new page or new window. After a user performs an exhibition information presentation activation operation, a new page or new window pops up, and exhibition information corresponding to product information is presented on the new page or new window. For example, an exhibition information presentation activation operation UI may be a button. When a user clicks the button or places a mouse on the button, a new page or new window pops up to present exhibition information of a product. Regardless of an original product browsing page, a product search page, a popup new page or a new window, exhibition information of a product may be directly displayed at a preset first position. Alternatively, only an exhibition information link item is presented. Alternatively, most of the exhibition information is presented with the rest of the exhibition information being reduced as an exhibition information link item for presentation. When a user clicks the exhibition information link item or puts the mouse on the exhibition information link item, a new presentation page or new presentation window is opened to display all or a part of the exhibition information. When a relatively large amount of content is displayed on a product browsing page or a product search page, or only a small new window or new page is allowed to pop up, it is appropriate to use an exhibition information link item, such that the exhibition information link item is displayed first, and a user is allowed to operate the exhibition information link item to further obtain exhibition information which is more specific and detailed. The exhibition information link item may be in a form of a button or a textual link.

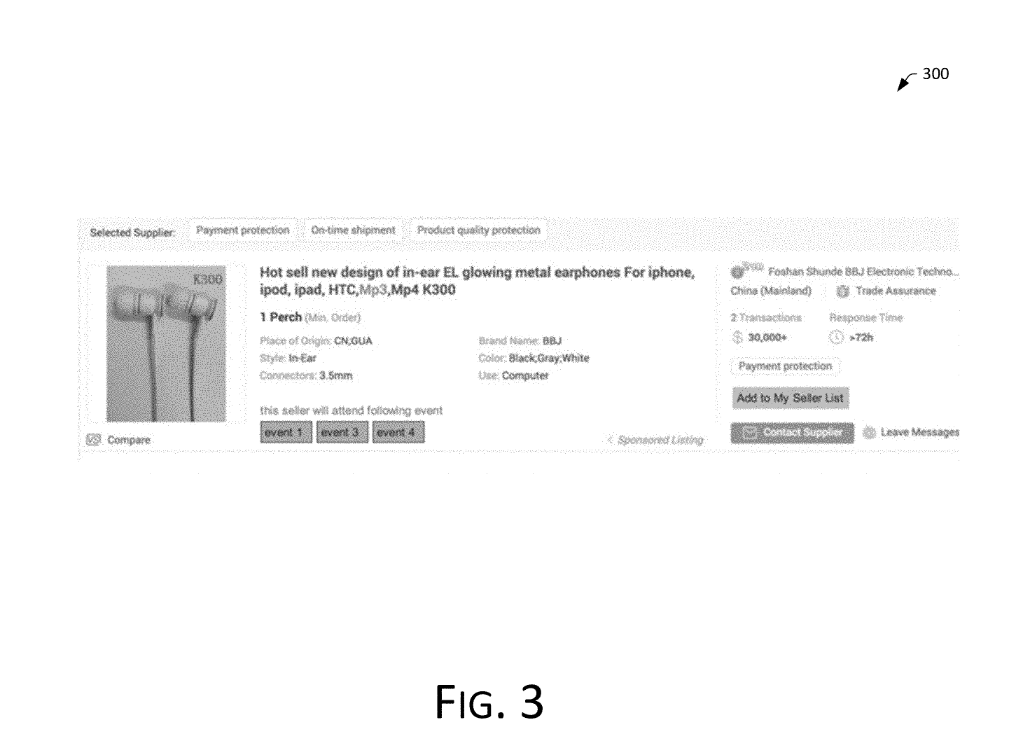

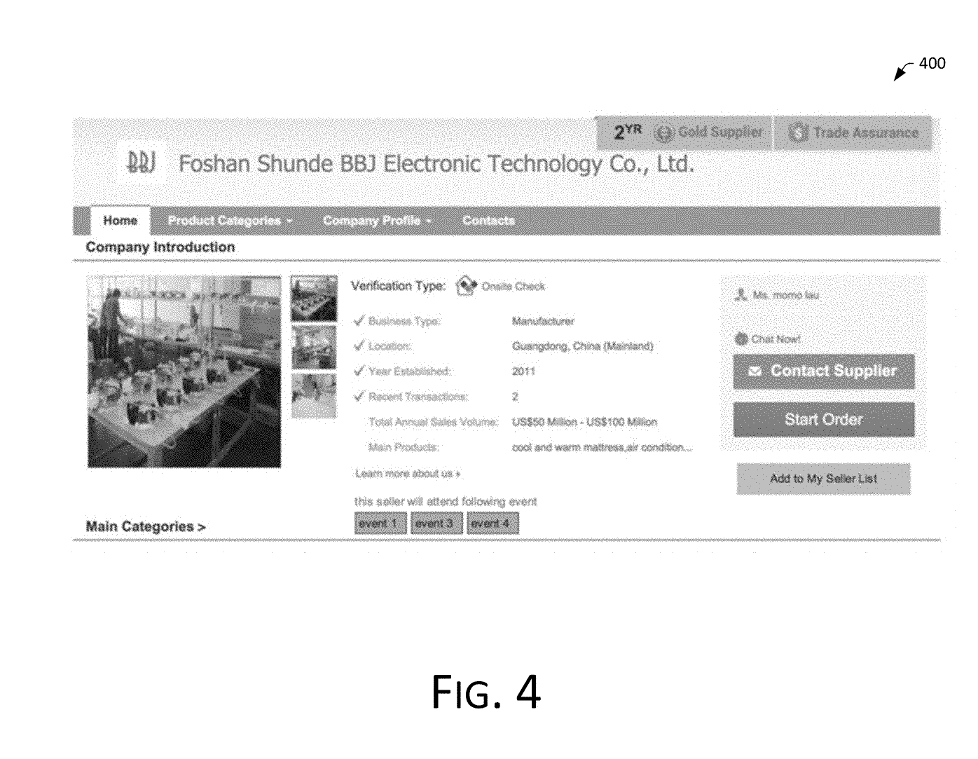

FIG. 3 is an example of presentation of exhibition information, and FIG. 4 is another example of presentation of exhibition information. FIG. 3 shows a product information presentation page 300 of a merchant. A textual description about exhibition(s) to attend is displayed at the lower part of a product introduction, under which three buttons are exhibition information link items of three exhibitions to attend. A respective new page is popped up after a user clicks each exhibition information link item, and the user may view detailed information about the respective exhibition on the new page. The three exhibition information link items as shown in FIG. 3 may also be combined as a single exhibition information link item. After a user clicks the single exhibition information link item, a new page is popped up, and the user may view information about all the exhibitions on the new page. FIG. 4 shows a portion of information about a merchant that is presented on a merchant product information page 400. A textual description about exhibition(s) to attend is located at the lower part, and three buttons are exhibition information link items. The three exhibition information link items as shown in FIG. 4 may also be combined as a single exhibition information link item. After a user clicks the exhibition information link item, a new page pops up, and corresponding exhibition information is presented on the new page.

The exhibition information presentation method provided in the present disclosure combines presentation of information of product(s) with presentation of information of exhibition(s). As such, when browsing or searching for a product, a user can instantly know information about an exhibition in which a product may be participated, thus expanding the coverage of exhibition information of the product, which helps the user to acquire exhibition information of offline interaction with a merchant more efficiently and more timely, and also helps increase the number of customers of the merchant and promote the product.

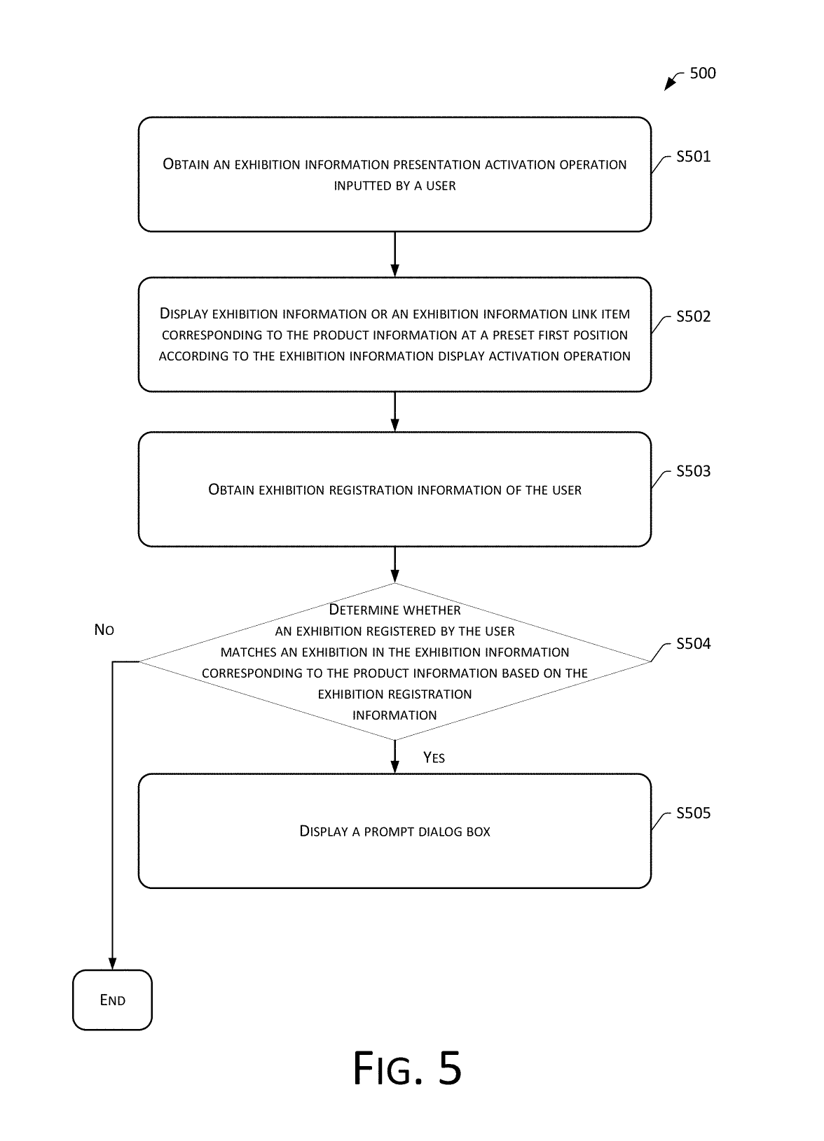

FIG. 5 shows a flowchart of another exhibition information presentation method 500 according to an exemplary embodiment of the present disclosure. As shown in FIG. 5, the method 500 may include the following operations.

S501 obtains an exhibition information presentation activation operation inputted by a user, the exhibition information presentation activation operation being associated with product information, and the product information being information about a product currently browsed or searched by the user.

S502 displays exhibition information or an exhibition information link item corresponding to the product information at a preset first position according to the exhibition information presentation activation operation.

S503 obtains exhibition registration information of the user.

S504 determines whether an exhibition registered by the user matches an exhibition in the exhibition information corresponding to the product information based on the exhibition registration information.

S505 displays a prompt dialog box if the exhibition registered by the user matches the exhibition information corresponding to the product information.

Details of S501 and S502 may be referenced to those of S101 and S102. In addition, to prevent a user from forgetting information about an exhibition he/she is interested in or intends to attend, and to remind the user to attend the exhibition in time and enhance the impression of product exhibition information for the user, in this embodiment, exhibition registration information of the user is further acquired in addition to S501 and S502. The exhibition registration information is inputted by the user in advance and is used for recording an exhibition that the user is interested in or intends to attend. The exhibition registration information may be queried and found from a database or storage space that stores exhibition registration information based on a user name of the user. After the exhibition registration information is obtained, exhibition information corresponding to information of product(s) currently browsed or searched by the user is compared with the exhibition registration information. If exhibition(s) registered by the user match(es) exhibition(s) in the exhibition information corresponding to the information of the product(s), a prompt dialog box is displayed. The prompt dialog box may be used for reminding the user one or more products that are participated in the exhibition(s) which the user is interested in or intends to attend. When the user registers with multiple exhibitions and exhibition information corresponding to product information includes multiple exhibitions, this indicates that all exhibitions registered by the user may be the same as all exhibitions in the exhibition information corresponding to the product information, some of the exhibitions registered by the user may be the same as all of the exhibitions in the exhibition information corresponding to the product information, all of the exhibitions registered by the user may be the same as some of the exhibitions in the exhibition information corresponding to the product information, or some of the exhibitions registered by the user may be the same as some of the exhibitions in the exhibition information corresponding to the product information. In other words, as long as any exhibition registered by the user is the same as any exhibition in the exhibition information corresponding to the product information, the prompt dialog box is displayed.

It should be noted that there may be more than one prompt dialog box. When a user currently browses a single product, a single prompt dialog box may be used for prompting exhibition(s) in which the current product that the user is interested in or intends to attend is participated. If the user currently browses multiple products or the user searches for product(s), multiple prompt dialog boxes may be used, with each prompting exhibition(s) in which each product that the user is interested in or intends to attend is participated.

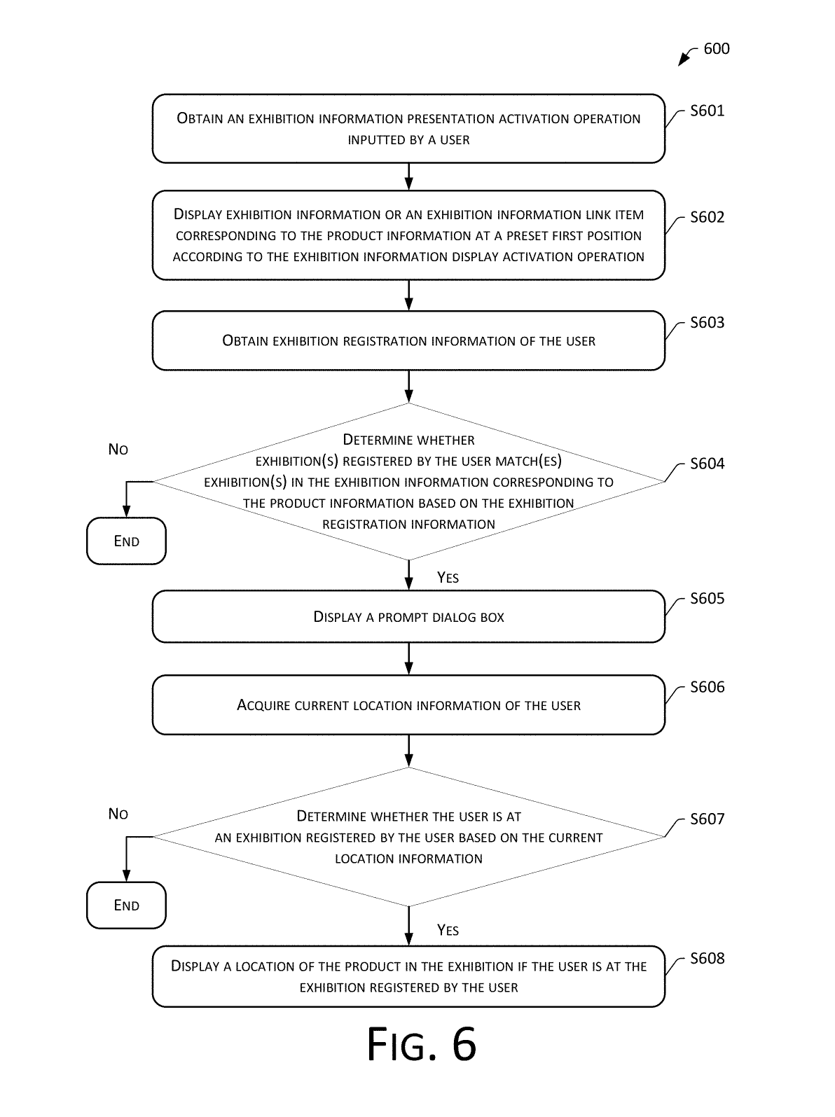

FIG. 6 shows a flowchart of another exhibition information presentation method 600 according to an exemplary embodiment of the present disclosure. As shown in FIG. 6, the method 600 may include the following operations.

S601 obtains an exhibition information presentation activation operation inputted by a user, the exhibition information presentation activation operation being associated with product information, and the product information being information about a product currently browsed or searched by the user.

S602 displays exhibition information or an exhibition information link item corresponding to the product information at a preset first position according to the exhibition information presentation activation operation.

S603 acquires exhibition registration information of the user.

S604 determines whether exhibition(s) registered by the user match(es) exhibition(s) in the exhibition information corresponding to the product information based on the exhibition registration information.

S605 displays prompt dialog box(s) if the exhibition(s) registered by the user match(es) the exhibition(s) in the exhibition information corresponding to the product information.

S606 acquires current location information of the user.

S607 determines whether the user is at an exhibition registered by the user based on the current location information.

S608 displays a location of the product in the exhibition if the user is at the exhibition registered by the user.

Details of S601 to S605 may be referenced to S501 to S505. In addition, current location information of the user may further be acquired. The current location information may be acquired using a positioning system of a terminal used by the user. After the current location information of the user is acquired, a determination is made as to whether the user is at an exhibition registered by the user. Location information of the exhibition registered by the user may be inputted in advance when the user inputs the exhibition registration information, or may be obtained by a system through querying map information according to a name of the exhibition in the exhibition registration information inputted by the user. If the user is at the exhibition registered by the user, i.e., the current location of the user is within a location range of the exhibition registered by the user, this indicates that the user is currently attending the exhibition. A location of the product which the user currently browses or searches for in the exhibition is displayed. Displaying the location of the product in the exhibition refers to displaying the location of the product in the exhibition that the user is currently attending, and such displaying may include acquiring a layout of the exhibition and marking the location of the product in the layout. The layout may be pre-stored in the system or may be retrieved from a web-connected exhibition system. The location of the product in the exhibition may be obtained from the exhibition information corresponding to the product. It should be noted that the location of the product in the exhibition is displayed only when the product is exhibited in the exhibition that the user is currently attending. If the exhibition information corresponding to the product does not include the exhibition that the user is currently attending, i.e., the current exhibition registered by the user is not the same as any exhibition in the exhibition information corresponding to the product information, no location of the product in the exhibition is displayed.

The solutions provided in the present embodiment displays a location of a product in an exhibition to a user when the user is visiting an exhibition, to facilitate the user to find the product, and thus improve the attraction of the product to customers.

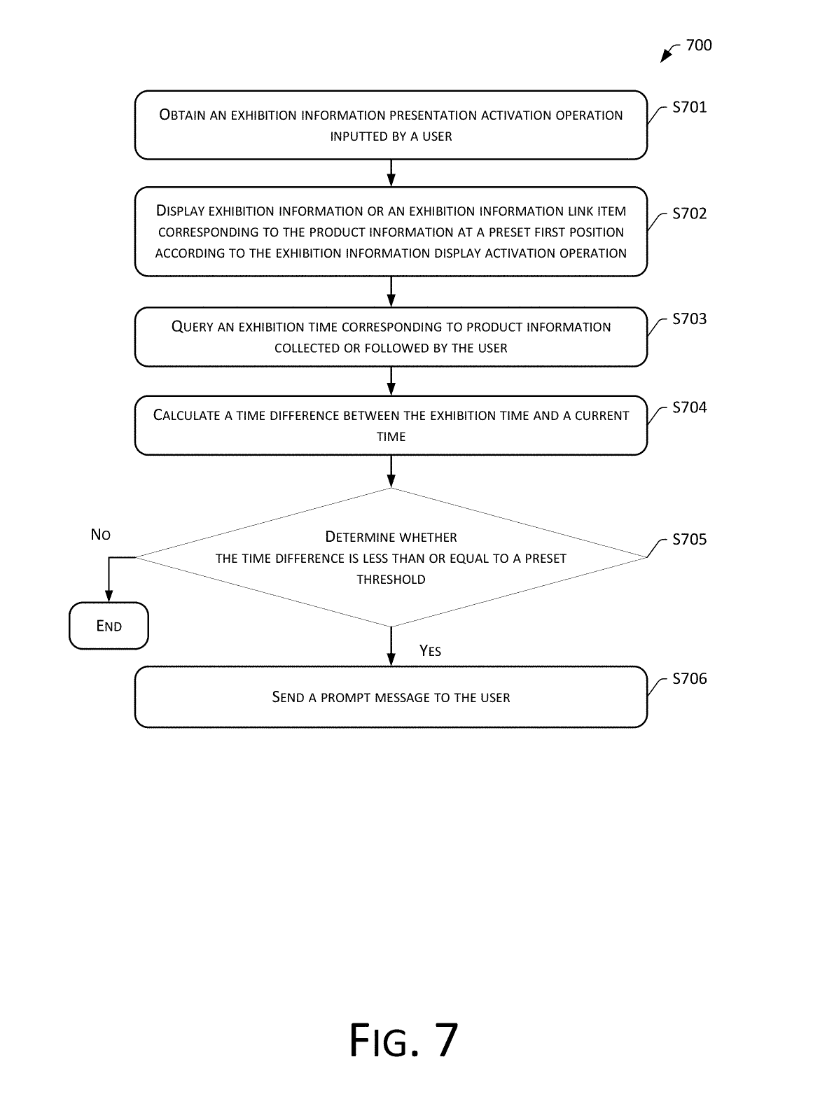

FIG. 7 shows a flowchart of another exhibition information presentation method 700 according to an exemplary embodiment of the present disclosure. As shown in FIG. 7, the method 700 may include the following operations.

S701 obtains an exhibition information presentation activation operation inputted by a user, the exhibition information presentation activation operation being associated with product information, and the product information being information about a product currently browsed or searched by the user.

S702 displays exhibition information or an exhibition information link item corresponding to the product information at a preset first position according to the exhibition information presentation activation operation.

S703 queries an exhibition time corresponding to product information collected or followed by the user.

S704 calculates a time difference between the exhibition time and a current time.

S705 determines whether the time difference is less than or equal to a preset threshold.

S706 sends a prompt message to the user if the time difference is less than or equal to the preset threshold, the prompt message being used for prompting the user with exhibition information corresponding to the collected or followed product information.

Details of S701 and S702 can be referenced to S101 and S102. In addition, for product information that is collected or followed by the user in advance, a corresponding exhibition time is queried. The exhibition time may be acquired from exhibition information corresponding to the product information. A time difference between the exhibition time and a current time is calculated. If the time difference is less than or equal to a preset threshold, this indicates that the exhibition in which the product collected or followed by the user is going to participate is approaching. Therefore, a prompt message is sent to the user to prompt the user with the exhibition information corresponding to the collected or followed product information, thus reminding the user to attend the related exhibition in time. The preset threshold may be set according to an actual situation, for example, set to be three days. When the time difference is less than or equal to the preset threshold, the prompt message may further be set to be sent at regular intervals, for example, sent in every three hours during daytime.

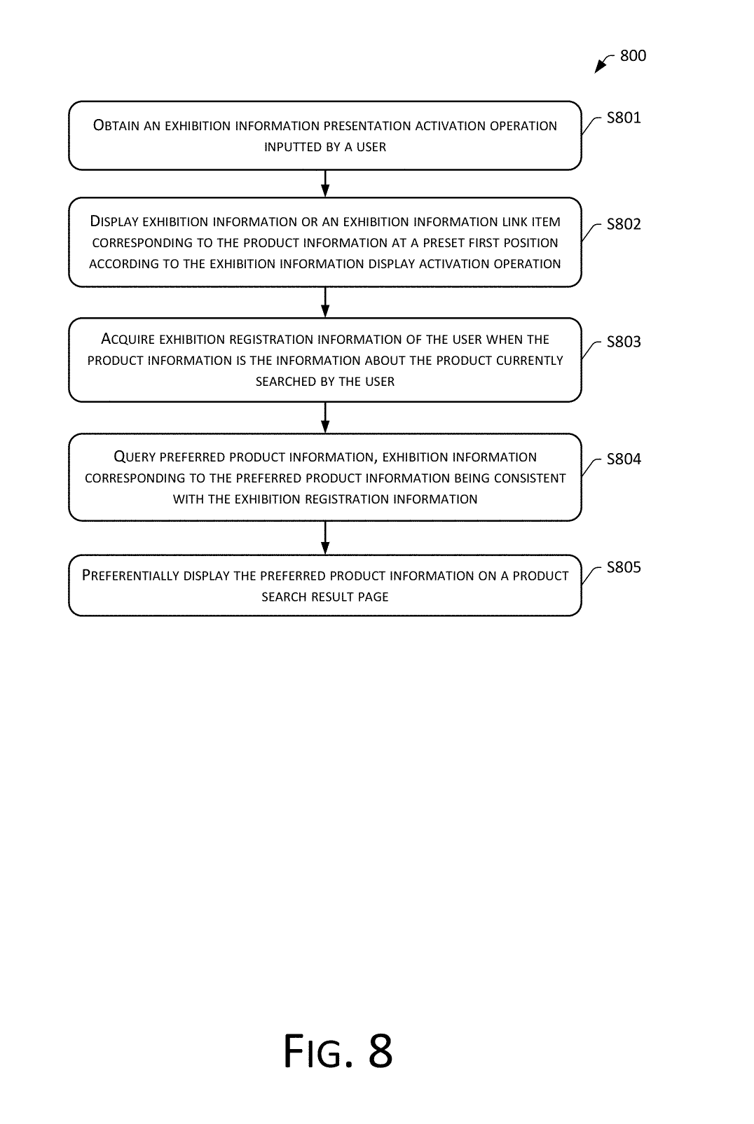

FIG. 8 is a flowchart of another exhibition information presentation method 800 according to an exemplary embodiment of the present disclosure. As shown in FIG. 8, the method 800 may include the following operations.

S801 obtains an exhibition information presentation activation operation inputted by a user, the exhibition information presentation activation operation being associated with product information, and the product information being information about a product currently browsed or searched by the user.

S802 displays exhibition information or an exhibition information link item corresponding to the product information at a preset first position according to the exhibition information presentation activation operation.

S803 acquires exhibition registration information of the user when the product information is the information about the product currently searched by the user.

S804 queries preferred product information, exhibition information corresponding to the preferred product information being consistent with the exhibition registration information.

S805 preferentially displays the preferred product information on a product search result page.

Details of S801 and S802 can be referenced to S101 and S102. In addition, when the product information is the information about the product currently searched by the user, i.e., when the user is searching for the product, exhibition registration information that is inputted by the user in advance is acquired. Exhibition information that is consistent with the exhibition registration information is searched for from the exhibition information corresponding to the found product information. Product information corresponding to the exhibition information that is consistent with the exhibition registration information, i.e., the preferred product information, is obtained. When a product search result page is displayed, the preferred product information that is found is preferentially displayed on the product search result page. In implementations, the exhibition information corresponding to the product information that is consistent with the exhibition registration information may include all exhibitions in the exhibition information corresponding to the product information being the same as all exhibitions in the exhibition registration information, some of the exhibitions in the exhibition information corresponding to the product information being the same as all of the exhibitions in the exhibition registration information, all of the exhibitions in the exhibition information corresponding to the product information being the same as some of the exhibitions in the exhibition registration information, or some of the exhibitions in the exhibition information corresponding to the product information being the same as some of the exhibitions in the exhibition registration information. In implementations, preferentially displaying may include arranging the preferred product information prior to other product information on the product search result page, highlighting the preferred product information, such as changing the font of the preferred product information to be red, or a combination of arranging the preferred product information prior to the other product information and highlighting the preferred product information. Thus, a user can preferentially see a product that is presented in an exhibition that the user attends, thereby improving the search efficiency of a product targeted by the user and enhancing the promotion of the product.

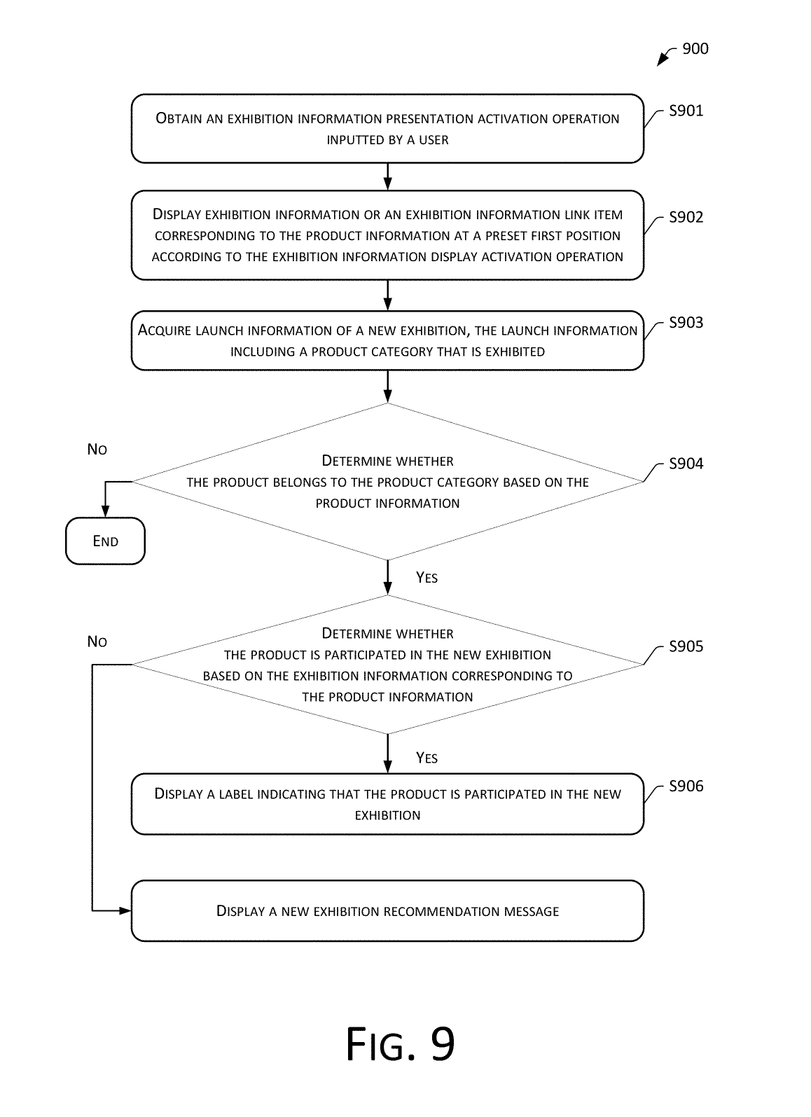

FIG. 9 is a flowchart of another exhibition information presentation method 900 according to an exemplary embodiment of the present disclosure. As shown in FIG. 9, the method 900 may include the following operations.

S901 obtains an exhibition information presentation activation operation inputted by a user, the exhibition information presentation activation operation being associated with product information, and the product information being information about a product currently browsed or searched by the user.

S902 displays exhibition information or an exhibition information link item corresponding to the product information at a preset first position according to the exhibition information presentation activation operation.

S903 acquires launch information of a new exhibition, the launch information including a product category that is exhibited.

S904 determines whether the product belongs to the product category based on the product information.

S905 determines whether the product is participated in the new exhibition based on the exhibition information corresponding to the product information in response to determining that the product belongs to the product category.

S906 displays a label indicating that the product is participated in the new exhibition in response to determining that the product is participated in the new exhibition.

S907 displays a new exhibition recommendation message in response to determining that the product is not participated in the new exhibition.

Details of S901 and S902 can be referenced to S101 and S102. In an application scenario, product information includes a product category. When setting or uploading the product information, a merchant may set up presentation information of a product, e.g., information about exhibitions in which the product has already participated, is currently participating, and is going to participate. In implementations, the presentation information of the product may further include a product category of an exhibition in which the product participates. When presenting the product information, an exhibition information presentation system may present exhibition information corresponding to the product information, and this is specific to the case where the presentation information has already been set. The exhibition information presentation system may be coupled to exhibition data systems of exhibition institutions. As a promotion and service platform of an exhibition, the exhibition information system may passively acquire, i.e., receive, launch information of a new exhibition transmitted by an exhibition data system, or actively acquire the launch information of the new exhibition from the exhibition data system according to a set time. The new exhibition may be an exhibition corresponding to launch information that is most recently received or acquired by the exhibition information presentation system. Multiple exhibitions generally exist. Accordingly, for each exhibition, launch information of a respective exhibition most recently received by the exhibition information presentation system may be considered as a new exhibition of the exhibition with respect to historical exhibitions. Therefore, there may also be multiple new exhibitions. A launch time of a new exhibition may not necessarily be a time in the future. The new exhibition may be an ongoing exhibition or may be an upcoming exhibition.

The exhibited product category that is included in the launch information may further include information such as the place, the time, and the scale of the exhibition. After acquiring the launch information of the new exhibition, the exhibition information presentation system may also obtain the product category exhibited in the new exhibition, and determine whether the product of the merchant belongs to the product category based on the product category in the product information that is already set or uploaded by the merchant. If the product belongs to the product category exhibited in the new exhibition, this indicates that the product can participate in the new exhibition. In this case, a determination is further made as to whether the product has already participated in the new exhibition based on the exhibition information corresponding to the product information. The determination may include determining whether the new exhibition exists in the exhibition information, e.g., searching the exhibition information for an exhibition having an exhibition name and a launch time that are the same as those of the new exhibition. If the new exhibition exists, this indicates that the product has participated in the new exhibition. If the new exhibition does not exist, this indicates that the product does not participate in the new exhibition. Additionally or alternatively, the determination may include comparing information of the new exhibition with the exhibition information. If an exhibition having a same name as the new exhibition exists in the exhibition information, a launch time of the exhibition is further compared with that of the new exhibition. If the times are also the same, this indicates that the product has participated in the new exhibition. Otherwise, this indicates that the product does not participate in the new exhibition.

If the product has participated in the new exhibition, a label indicating that the product has participated in the new exhibition is displayed on a page where the product information is located to remind the user to visit the exhibition, thus achieving an effect of promoting both the product and the exhibition. If the page where the product information is located is a separate product information page or a merchant product information page, a label indicating a single product or products of a merchant that have participated in the new exhibition is displayed on the page because the products of the merchant generally participate in a same exhibition. For the merchant product information page, a label indicating that the product has participated in the new exhibition may also be displayed at a presentation item setting position of a respective piece of information about each product that participates in the new exhibition. This is especially true when there are multiple new exhibitions and different products of the merchant participate in different new exhibitions. In these cases, corresponding to a piece of information about each product participating in a new exhibition, a label indicating that the respective product has participated in the new exhibition is displayed, so that related new exhibition participation information can be more clearly displayed to the user. On a page with multiple pieces of product information, such as a search result page, corresponding to a piece of information of each product, a label indicating that the respective product has participated in the new exhibition may also be displayed at a presentation item setting position of the piece of information of the product. If the product does not participate in the new exhibition, a new exhibition recommendation message is displayed to remind the user or the merchant that the product may participate in the new exhibition. Because recommending new exhibitions that a product can participate is more valuable for merchants, a new exhibition recommendation message may be displayed only on a product information page displayed after login of a merchant account. If the product does not belong to the product category, this indicates that the product cannot participate in the new exhibition, and therefore the process is ended.

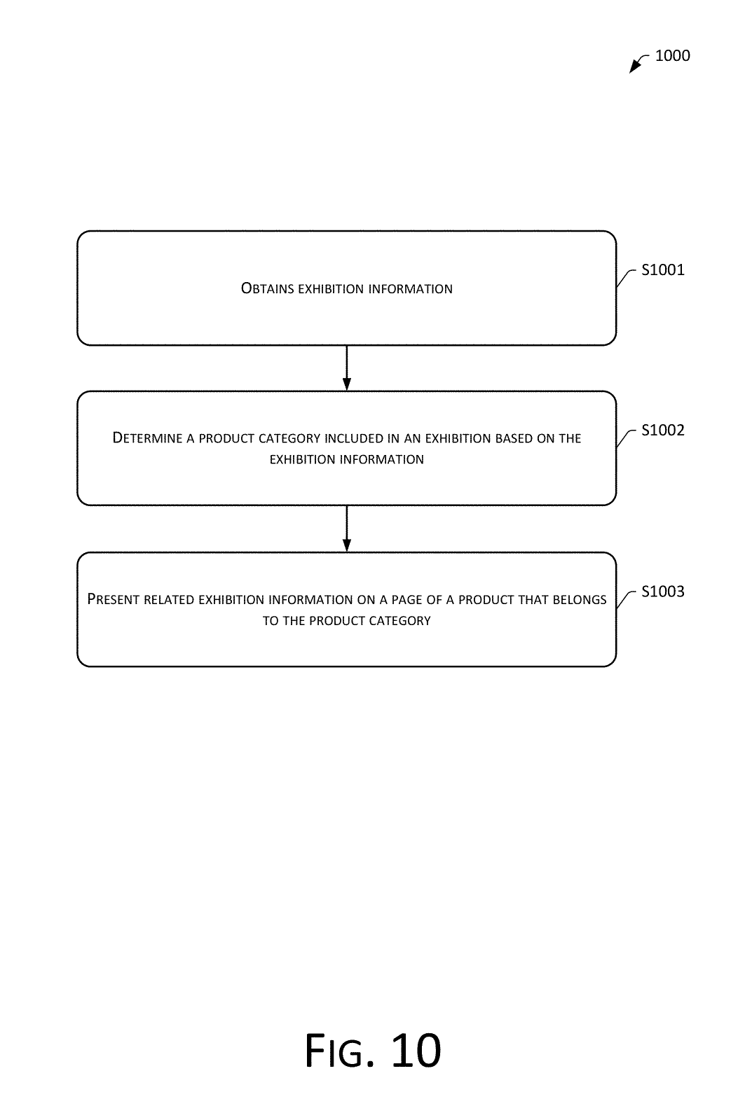

FIG. 10 is a flowchart of another exhibition information presentation method 1000 according to an exemplary embodiment of the present disclosure. As shown in FIG. 10, the method 1000 may include the following operations.

S1001 obtains exhibition information.

S1002 determines a product category included in an exhibition based on the exhibition information.

S1003 presents related exhibition information on a page of a product that belongs to the product category.

In implementations, a product platform or an e-commerce platform may define a protocol with an exhibition platform in advance. An exhibition information presentation system of the product platform or e-commerce platform may read exhibition information, especially new exhibition information, from the exhibition platform according to the protocol in a regular basis or an irregular basis such as reading according to a presentation demand. Additionally or alternatively, when exhibition information stored in the exhibition platform is updated, the exhibition platform may send an update message to the exhibition information presentation system, and the exhibition information presentation system may read new exhibition information from the exhibition platform after receiving the update message. Additionally or alternatively, the exhibition platform may regularly send exhibition information to the exhibition information presentation system. Additionally or alternatively, when exhibition information in the exhibition platform is updated, the exhibition platform sends new exhibition information to the exhibition information presentation system, and the exhibition information presentation system receives the exhibition information. The exhibition information includes product categor(ies) that is/are exhibited in an exhibition, and may further include information such as the time, the location, the booth distribution, the product introduction, the manufacturer introduction, and the marketing activities associated with the exhibition.

After the exhibition information is acquired, a product category included in the exhibition is parsed out according to the composition of the exhibition information. If a product category attribute is set in the exhibition information, the product category attribute can be directly read from the exhibition information, thereby determining the product category included in the exhibition. After the product category is determined, matching is performed between the product category and product categories in the product platform or e-commerce platform. If the product category does not exist in the product platform, the process is ended. If the product category exists, one or more products belonging to the product category are searched for in the product platform, and respective exhibition information is presented on page(s) of the one or more products. Presentation of the exhibition information may be a presentation of complete exhibition information. In implementations, for each product, a portion corresponding to the respective product from the exhibition information may be extracted, and the portion of exhibition information corresponding to the respective product may be presented on a page of the respective product. The presentation may include setting a presentation area on the page of the product in advance and presenting the exhibition information related to the product in the preset presentation area, or presenting the related exhibition information in a popup window on the page of the product or a new page.

It should be noted that a representation format of a product category may be specified in the protocol when the product platform or e-commerce platform defines the protocol with the exhibition platform, so as to facilitate performing the matching for the product category.

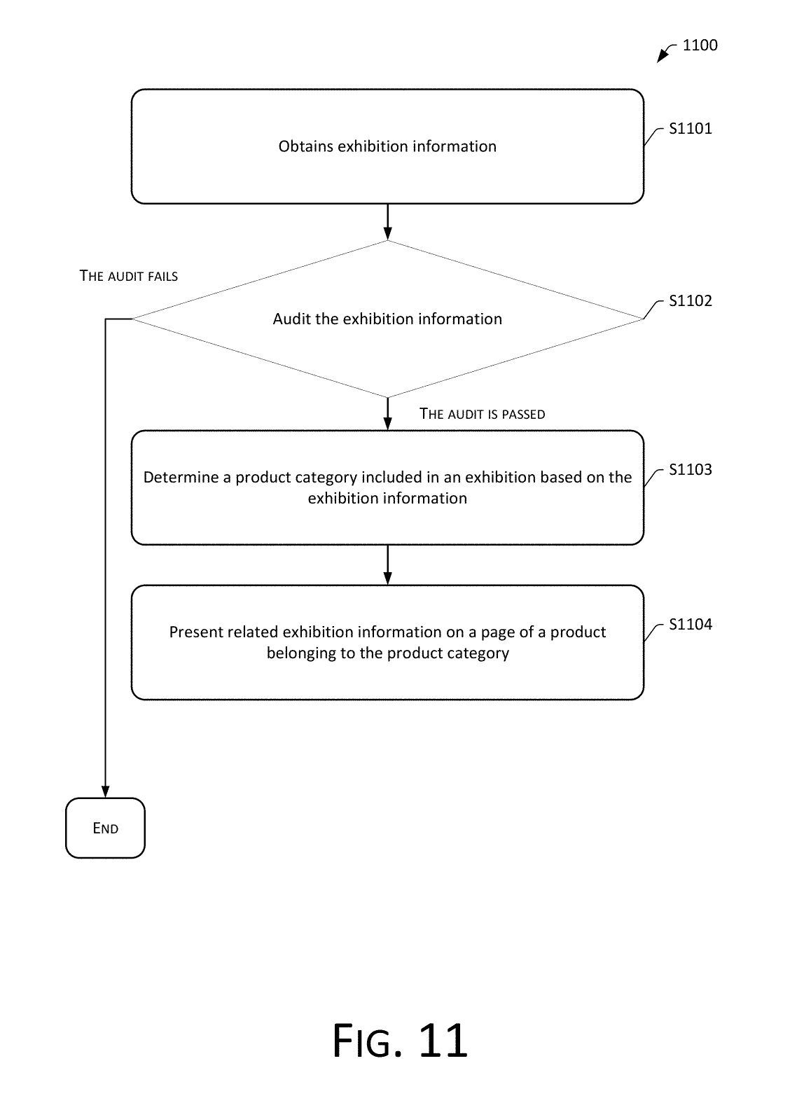

FIG. 11 is a flowchart of another exhibition information presentation method 1100 according to an exemplary embodiment of the present disclosure. As shown in FIG. 11, the method 1100 may include the following operations.

S1101 obtains exhibition information.

S1102 audits the exhibition information.

S1103 determines a product category included in an exhibition based on the exhibition information if the exhibition information passes the audit.

S1104 presents related exhibition information on a page of a product belonging to the product category.

S1101 is the same as S1001, and S1104 is the same as S1003. After exhibition information is acquired, the exhibition information is audited. For example, auditing is performed as to whether the exhibition information is illegal or whether the exhibition information has expired. If the exhibition information passes the auditing, a product category included in an exhibition is determined based on the exhibition information. Auditing the exhibition information helps to ensure the security of a system and the validity of program execution.

The exhibition presentation method provided in the present embodiment of the present disclosure cooperates with an exhibition platform to automatically acquire exhibition information from the exhibition platform, determines a product category included in the exhibition information, and displays complete exhibition information or corresponding exhibition information of a product belonging to the product category on a page of the product, thus implementing automatic product-based and targeted promotion of exhibition information. This significantly reduces the workload, improves the efficiency of promotion, and also enhances the timeliness and the coverage rate of the promotion of exhibition information, as compared with existing product classification and promotion page distribution that is manually performed based on exhibition information.

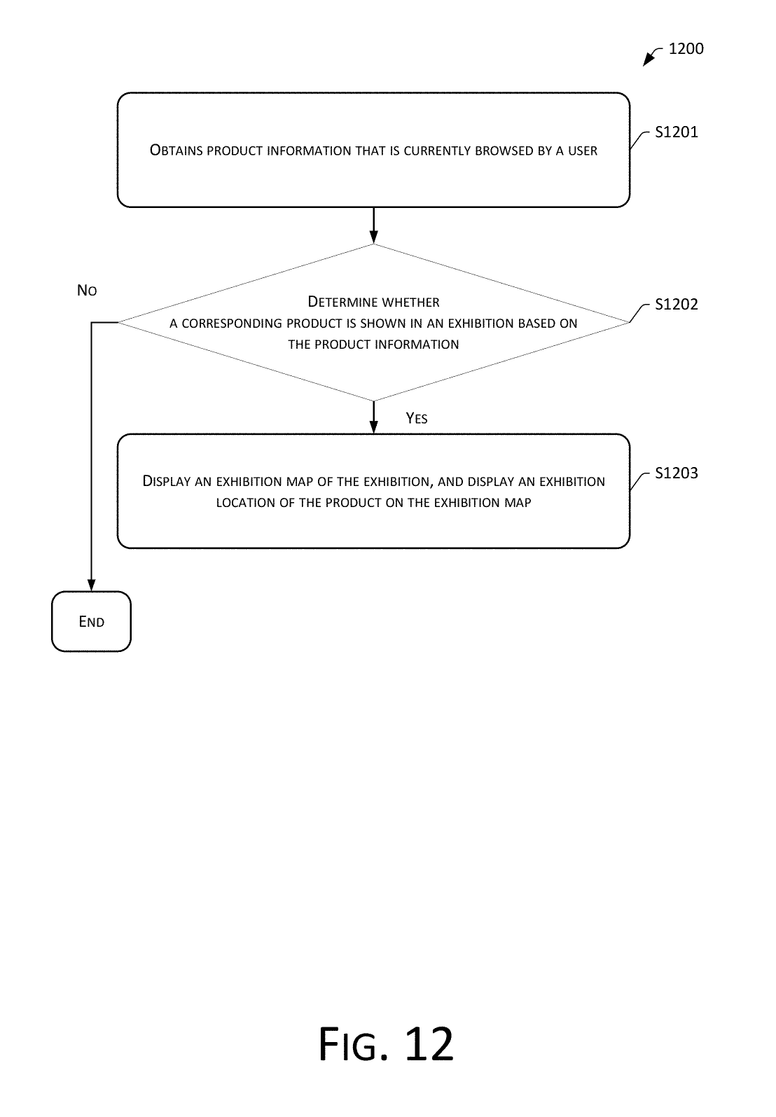

FIG. 12 is a flowchart of an exhibition navigation method 1200 according to an exemplary embodiment of the present disclosure. As shown in FIG. 12, the method 1200 may include the following operations.

S1201 obtains product information that is currently browsed by a user.

S1202 determines whether a corresponding product is shown in an exhibition based on the product information.

S1203 displays an exhibition map of the exhibition, and displays an exhibition location of the product on the exhibition map if the product is shown in the exhibition.

The method provided in the present embodiment may be applied to a product platform (or an Application (APP)), an e-commerce platform (or an APP), an exhibition platform (or an APP), or the like. When a user browses a product, corresponding product information is acquired. A search is performed to determine whether the product corresponding to the product information exists in pre-stored product-on-exhibition information (which is generally included in exhibition information). If the product exists, a determination can be made that the product is or will be shown in certain exhibition(s), and the exhibition(s) in which the product is or will be shown can be determined based on the product-on-exhibition information corresponding to the product. If the product does not exist, the process is ended.

If the product exists (i.e., if the product is or will be shown in an exhibition), an exhibition map of the exhibition (i.e., an exhibition map of the exhibition to which the product belongs) is displayed. Location information of the product is found in product exhibition location information of the exhibition. An exhibition location of the product is displayed on the exhibition map according to the location information. The exhibition map of the exhibition and exhibition location information related to the exhibition (including the product exhibition location information) are both stored in advance. An exhibition location of the product may further be highlighted, for example, partially enlarged in display or displayed with different colors, to enable a user to see it at first glance.

The method provided in the present embodiment of the present disclosure displays a corresponding exhibition map and an exhibition location of a product in real time based on the product browsed by a user, thus achieving to view information about an exhibition when viewing information of a product. This facilitates the user to go to the exhibition and also improves the promotion strength of the exhibition.

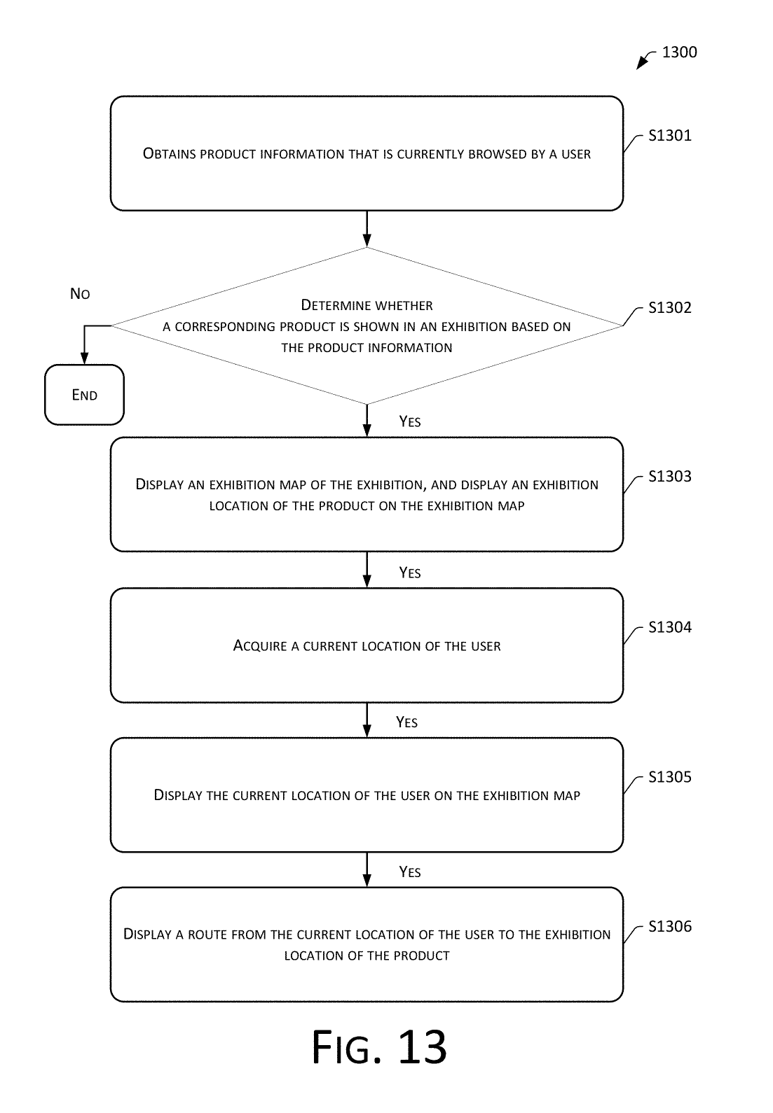

FIG. 13 is a flowchart of another exhibition navigation method 1300 according to an exemplary embodiment of the present disclosure. As shown in FIG. 13, the method 1300 may include the following operations.

S1301 obtains product information that is currently browsed by a user.

S1302 determines whether a corresponding product is shown in an exhibition according to the product information.

S1303 displays an exhibition map of the exhibition, and displays an exhibition location of the product on the exhibition map if the product is shown in the exhibition.

S1304 acquires a current location of the user.

S1305 displays the current location of the user on the exhibition map.

S1306 displays a route from the current location of the user to the exhibition location of the product.

S1301 to S1303 are the same as S1201 to S1203. In addition to the exhibition location of the product, a current location of the user may also be acquired through positioning information of a client terminal of the user, for example, GPS (i.e., Global Positioning System) positioning information or base station positioning information of a mobile client terminal of the user, or an IP (i.e., Internet Protocol) address of a PC (i.e., personal computer) of the user. The current location of the user may then be displayed on the exhibition map. It should be noted that, if the exhibition map only includes a portion related to an exhibition while the current location of the user is not within the exhibition, prompt information may be displayed to prompt that the user is not at the exhibition currently, or an error reporting message is displayed. If the exhibition map is in a full-map mode, for example, Amap mode, and the map of the exhibition is displayed in the Amap, the current location of the user is displayed on the full map. If the current location of the user is within the exhibition, the current location of the user is displayed on the exhibition map. In addition to the current location of the user, a route from the current location of the user to the exhibition location of the product may also be displayed. The route may be a line from the current location of the user to the exhibition location of the product. If the user is at the exhibition, the route may be a passage route from the current location of the user to the exhibition location of the product. If the current location of the user is on a full map, the route may be a geographical location navigation route. The geographical location navigation route may be calculated using map software.

According to a product browsed by a user, the exhibition navigation method provided in this embodiment displays a corresponding exhibition map and an exhibition location of the product in real time, and displays a location of the user as well as a route from the user to the exhibition location of the product, facilitating the user to go to the exhibition.

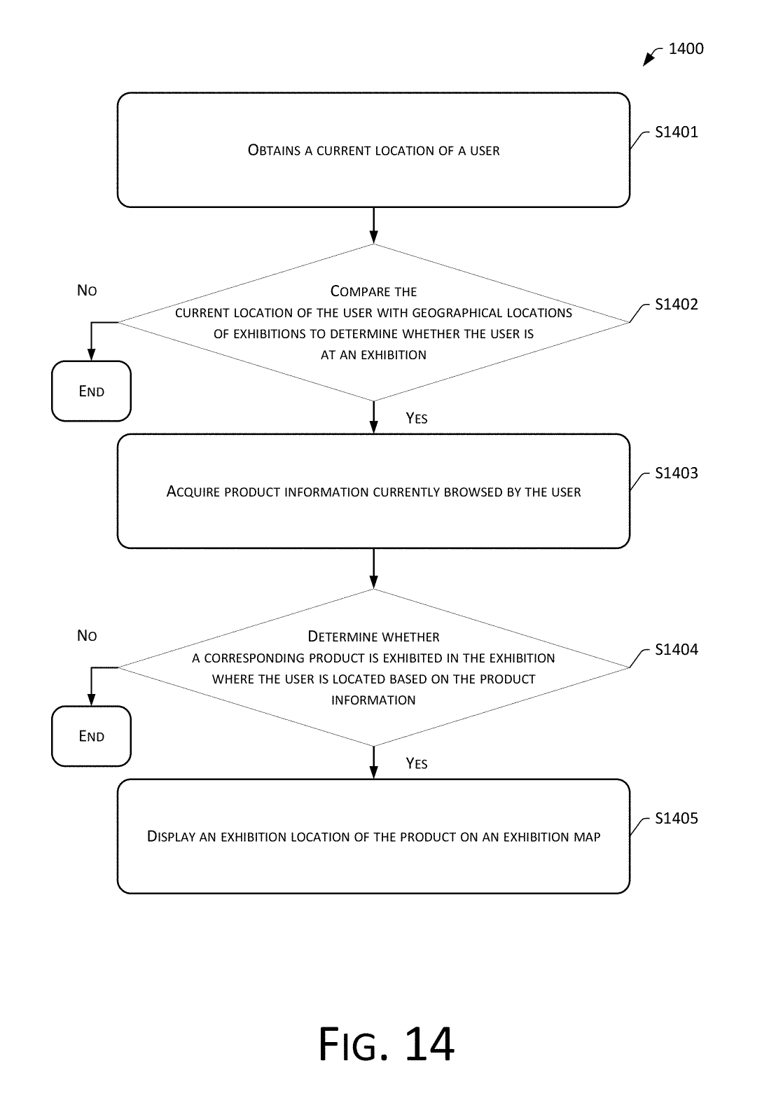

FIG. 14 is a flowchart of another exhibition navigation method 1400 according to an exemplary embodiment of the present disclosure. As shown in FIG. 14, the method 1400 may include the following operations.

S1401 obtains a current location of a user.

S1402 compares the current location of the user with geographical locations of exhibitions to determine whether the user is at an exhibition.

S1403 acquires product information currently browsed by the user if the user is at an exhibition.

S1404 determines whether a corresponding product is exhibited in the exhibition where the user is located based on the product information.

S1405 displays an exhibition location of the product on an exhibition map if the product is exhibited in the exhibition where the user is located.

The present embodiment may be applied to a product platform (or an Application (APP)), an e-commerce platform (or an APP), an exhibition platform (or an APP), or the like. Geographical locations of exhibitions are pre-stored. After a current location of a user is acquired, the current location of the user is compared with the geographical locations of the exhibitions. If the current location of the user is the same as a geographical location of an exhibition, or is included in a geographical location range of the exhibition, the user is determined to be at the exhibition. Otherwise, the user currently is not at any of the exhibitions, and the process may be ended. In response to determining that the user is at an exhibition, an exhibition map of the exhibition may be displayed. Alternatively, the exhibition map may not be displayed at this time. After determining that the user is at an exhibition, product information currently browsed by the user is acquired, and the product information is compared with product information of the exhibition where the user is located to determine whether a product corresponding to the product information is exhibited in the exhibition where the user is located. If the product information of the exhibition where the user is located includes the product information that is currently browsed by the user, a determination is made that the product currently browsed by the user is exhibited in the exhibition where the user is located. Exhibition location of the product currently browsed by the user is found from among pre-stored product exhibition locations of the exhibition. If the exhibition map has been displayed previously, the exhibition location of the product is displayed on the exhibition map. If the exhibition map has not previously been displayed, the exhibition map is displayed, and the exhibition location of the product is displayed on the exhibition map. The exhibition location of the product may be highlighted to be easily viewed by the user.

The exhibition navigation method provided in this embodiment of the present disclosure provides a user with real-time navigation to an exhibition location of a product when the user is at an exhibition, making it convenient for the user to rapidly position the product in the exhibition.

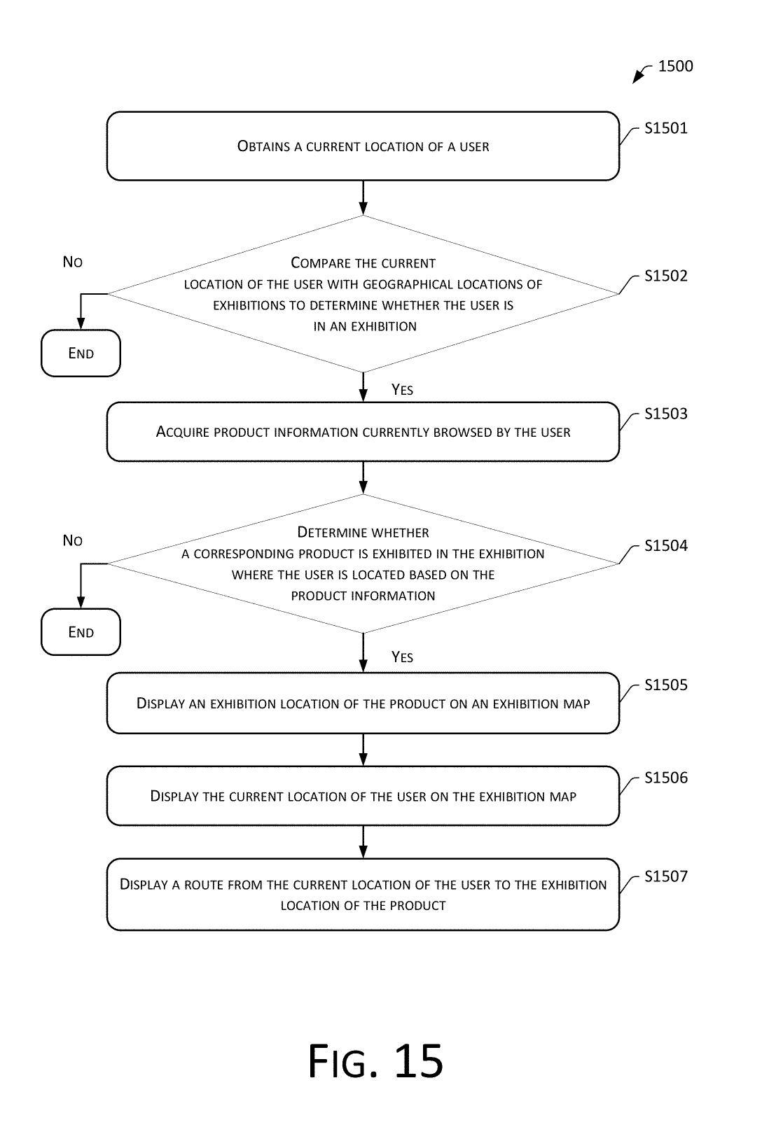

FIG. 15 is a flowchart of another exhibition navigation method 1500 according to an exemplary embodiment of the present disclosure. As shown in FIG. 15, the method 1500 may include the following operations.

S1501 obtains a current location of a user.

S1502 compares the current location of the user with geographical locations of exhibitions to determine whether the user is in an exhibition.

S1503 acquires product information currently browsed by the user if the user is in an exhibition.

S1504 determines whether a corresponding product is exhibited in the exhibition where the user is located based on the product information.

S1505 displays an exhibition location of the product on an exhibition map if the product is in the exhibition where the user is located.

S1506 displays the current location of the user on the exhibition map.

S1507 displays a route from the current location of the user to the exhibition location of the product.

S1501 to S1505 are the same as S1401 to S1405. In addition to the exhibition location of the product, the current location of the user and the route from the current location of the user to the exhibition location of the product may also be displayed on the map to improve the efficiency of viewing the exhibition by the user. The route may be a line from the current location of the user to the exhibition location of the product, or a passage route from the current location of the user to the exhibition location of the product.

Through the foregoing description of the method embodiments, one skilled in the art can clearly understand that the present disclosure can be implemented by software and a necessary universal hardware platform, and may also be implemented by hardware. In many instances, the former may be a better implementation. Based on such understanding, the essence of the technical solutions of the present disclosure or the portion contributing to the existing technologies may be embodied in a form of a software product and stored in a storage media, and may include instructions to cause an intelligent device to execute all or some of the operations of the methods in the embodiments of the present disclosure. The foregoing storage media may include various types of media capable of storing data and program code, such as a read-only memory (ROM), a random access memory (RAM), a magnetic disk, or an optical disc, etc.

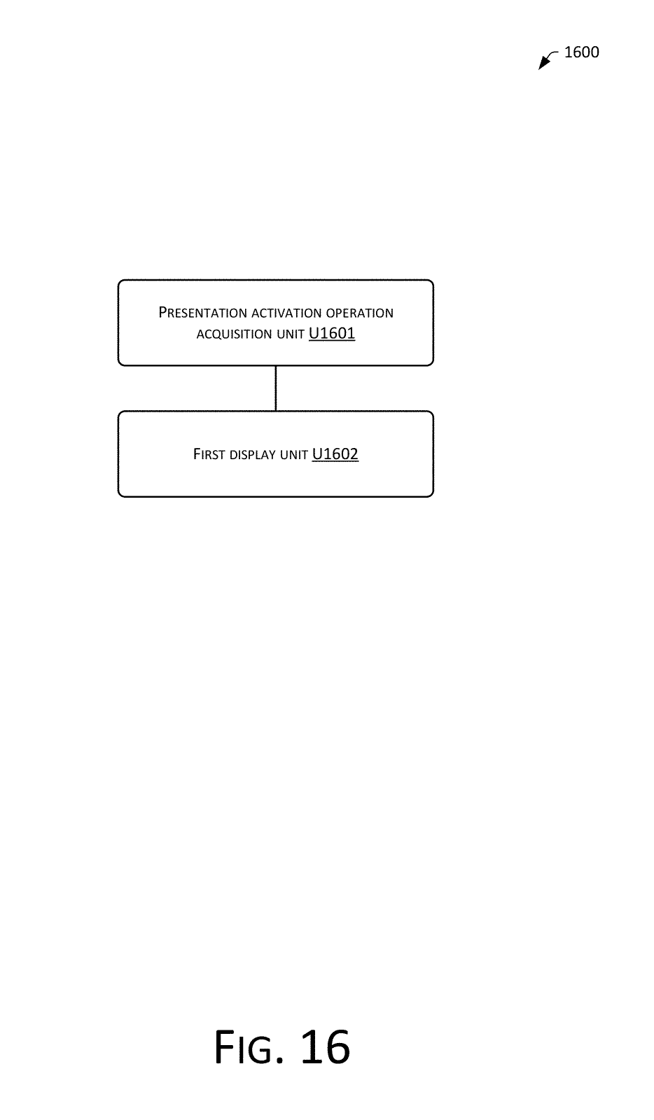

FIG. 16 is a structural diagram of an exhibition information presentation system 1600 according to an exemplary embodiment of the present disclosure. As shown in FIG. 16, the system 1600 may include a presentation activation operation acquisition unit U1601 configured to acquire an exhibition information presentation activation operation inputted by a user, the exhibition information presentation activation operation being associated with product information, and the product information being information about a product currently browsed or searched by the user; and a first display unit U1602 configured to display exhibition information or an exhibition information link item corresponding to the product information at a preset first position according to the exhibition information presentation activation operation.

In implementations, an exhibition information presentation activation operation UI (i.e., a user interface) is set up on a product information platform. The exhibition information presentation activation operation UI corresponds to product information, and the UI may be placed on a product browsing page or a product search page. The product browsing page may be an individual product information page or a merchant product information page. The exhibition information presentation activation operation UI may also be on the product search page. In an application scenario, the exhibition information presentation activation operation UI may be displayed on a product search result page after a product search is completed, and may correspond to each product. In another application scenario, a search box may serve as an exhibition information presentation activation operation UI. A user operation of confirming a search after entering a product to be searched for may also be an exhibition information presentation activation operation. A system searches for the product according to the operation, displays search results, and presents exhibition information corresponding to each search result on a search result page. When the user performs the exhibition information presentation activation operation, the operation is performed for exhibition information of each product. As the exhibition information presentation activation operation UI corresponds to the product information, the exhibition information presentation activation operation is associated with the product information.

The exhibition information presentation activation operation UI may be a button, a checkbox, or the like. The exhibition information corresponding to the product information is configured in advance. The presentation activation operation acquisition unit U1601 is associated with the exhibition information presentation activation operation UI, and the exhibition information presentation activation operation inputted by the user is acquired through the exhibition information presentation activation operation UI.

In implementations, the exhibition information link item may be used for acquiring a link operation inputted by the user, and a corresponding exhibition information presentation page may be opened according to the link operation. The first position is set in advance. In an application scenario, the first position may be an exhibition information presentation position reserved on an original product browsing page, or may be an exhibition information presentation position corresponding to each piece of product information on an original product search page. The first position may be set according to a requirement of design of the product browsing or search page. In another application scenario, the first position is an exhibition information presentation position pre-configured by the first display unit U1602 on a popup new page or new window according to the exhibition information presentation activation operation. Regardless of an original product browsing page, a product search page, a popup new page or a new window, exhibition information of a product may be directly displayed at a preset first position. Alternatively, only an exhibition information link item is presented. Alternatively, most of the exhibition information is presented with the rest of the exhibition information being reduced as an exhibition information link item for presentation. When a user clicks the exhibition information link item or puts the mouse on the exhibition information link item, a new presentation page or new presentation window is opened to display all or a part of the exhibition information. When a relatively large amount of content is displayed on a product browsing page or a product search page, or only a small new window or new page is allowed to pop up, it is appropriate to use an exhibition information link item.

The exhibition information presentation system 1600 combines presentation of product information with presentation of exhibition information. A such, when browsing or searching for a product, a user can instantly know information about an exhibition which the product participates in, thus expanding the coverage of exhibition information of the product, which helps the user to acquire exhibition information of offline interaction with a merchant more efficiently and more timely.

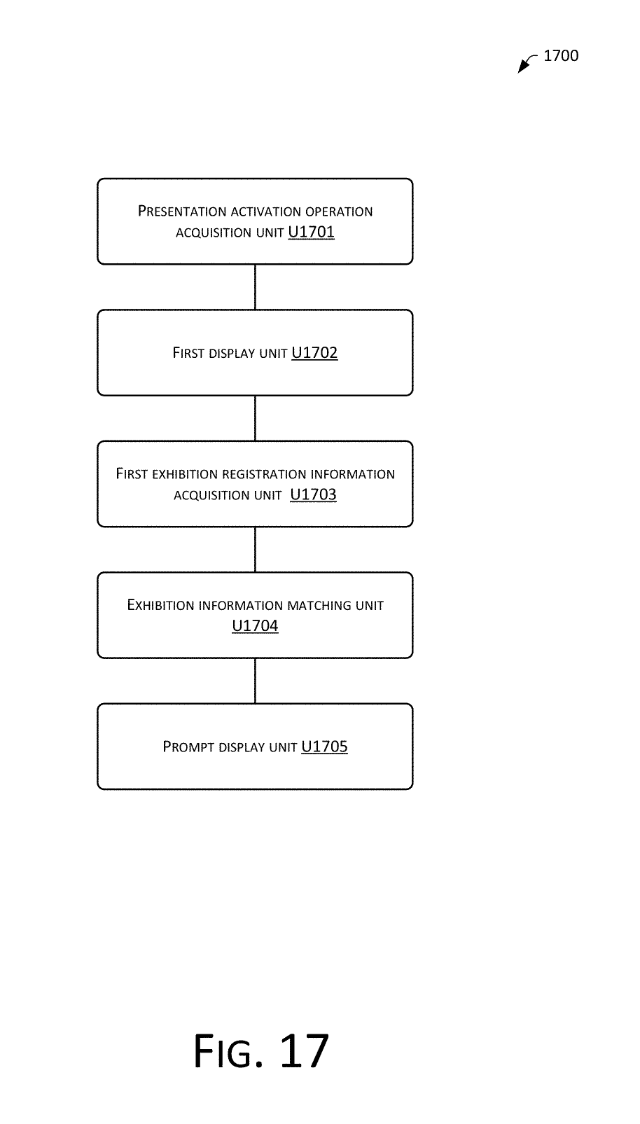

FIG. 17 is a structural diagram of another exhibition information presentation system 1700 according to an exemplary embodiment of the present disclosure. As shown in FIG. 17, the system 1700 may include a presentation activation operation acquisition unit U1701 configured to acquire an exhibition information presentation activation operation inputted by a user, the exhibition information presentation activation operation being associated with product information, and the product information being information about a product currently browsed or searched by the user; a first display unit U1702 configured to display exhibition information or an exhibition information link item corresponding to the product information at a preset first position according to the exhibition information presentation activation operation; a first exhibition registration information acquisition unit U1703 configured to acquire exhibition registration information of the user; an exhibition information matching unit U1704 configured to determine whether an exhibition registered by the user matches an exhibition in the exhibition information corresponding to the product information based on the exhibition registration information; and a prompt display unit U1705 configured to display a prompt dialog box if the exhibition registered by the user matches the exhibition in the exhibition information corresponding to the product information.

In implementations, to prevent a user from forgetting information about an exhibition he/she is interested in or intends to attend, and to remind the user to attend the exhibition in time and enhance the impression of the product exhibition information for the user, the exhibition registration information of the user is further acquired by the first exhibition registration information acquisition unit U1703. The exhibition registration information is inputted by the user in advance and is used for recording an exhibition that the user is interested in or intends to attend. The first exhibition registration information acquisition unit U1703 may query the exhibition registration information from a database or storage space that stores exhibition registration information based on a user name of the user. After the first exhibition registration information acquisition unit U1703 obtains the exhibition registration information, the exhibition information matching unit U1704 compares the exhibition information corresponding to the product information currently browsed or searched by the user with the exhibition registration information. If the exhibition registered by the user matches the exhibition in the exhibition information corresponding to the product information, the prompt display unit U1705 displays a prompt dialog box. The prompt dialog box may be used for reminding the user one or more products that are participated in the exhibition(s) which the user is interested in or intends to attend. When the user registers with multiple exhibitions and exhibition information corresponding to product information includes multiple exhibitions, this indicates that all exhibitions registered by the user may be the same as all exhibitions in the exhibition information corresponding to the product information, some of the exhibitions registered by the user may be the same as all of the exhibitions in the exhibition information corresponding to the product information, all of the exhibitions registered by the user may be the same as some of the exhibitions in the exhibition information corresponding to the product information, or some of the exhibitions registered by the user may be the same as some of the exhibitions in the exhibition information corresponding to the product information.

The prompt display unit U1705 may display more than one prompt dialog box. When a user currently browses a single product, a single prompt dialog box may be used for prompting exhibition(s) in which the current product that the user is interested in or intends to attend is participated. If the user currently browses multiple products or the user searches for product(s), multiple prompt dialog boxes may be used, with each prompting exhibition(s) in which each product that the user is interested in or intends to attend is participated.

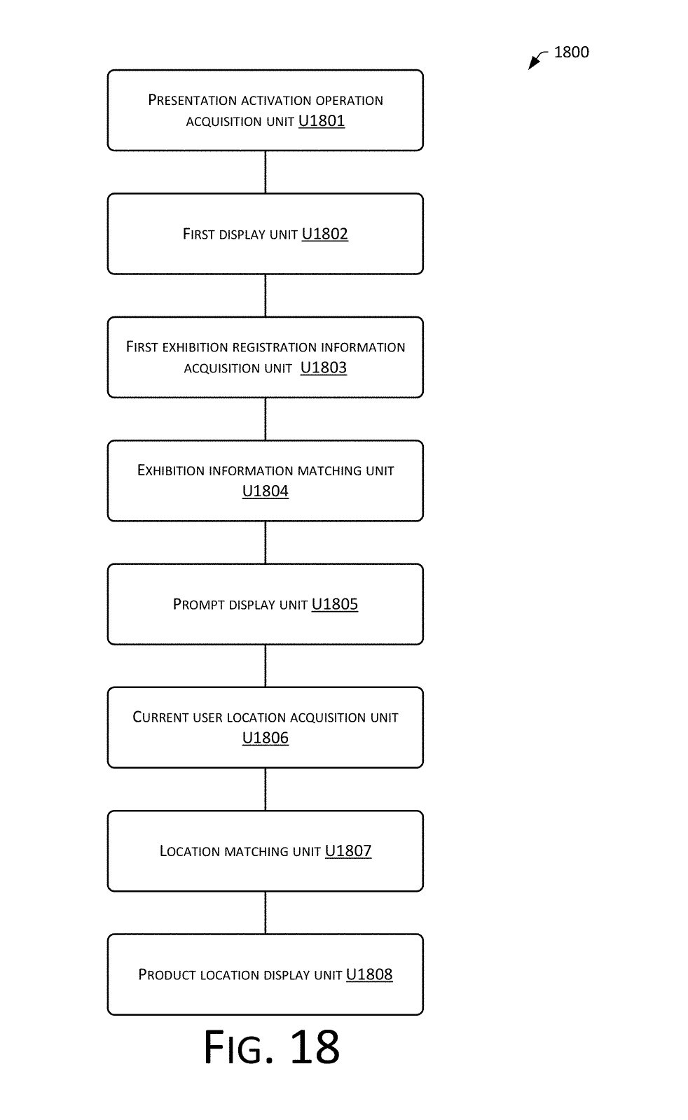

FIG. 18 is a structural diagram of another exhibition information presentation system 1800 according to an exemplary embodiment of the present disclosure. As shown in FIG. 18, the system 1800 may include a presentation activation operation acquisition unit U1801 configured to acquire an exhibition information presentation activation operation input by a user, the exhibition information presentation activation operation being associated with product information, and the product information being information about a product currently browsed or searched by the user; a first display unit U1802 configured to display, at a preset first position, exhibition information or an exhibition information link item corresponding to the product information according to the exhibition information presentation activation operation; a first exhibition registration information acquisition unit U1803 configured to acquire exhibition registration information of the user; an exhibition information matching unit U1804 configured to determine whether an exhibition registered by the user is the same as an exhibition in the exhibition information corresponding to the product information based on the exhibition registration information; a prompt display unit U1805 configured to display a prompt dialog box if the exhibition registered by the user is the same as the exhibition in the exhibition information corresponding to the product information; a current user location acquisition unit U1806 configured to acquire current location information of the user; a location matching unit U1807 configured to determine whether the user is in the exhibition registered by the user based on the current location information; and a product location display unit U1808 configured to display a location of the product in the exhibition if the user is in the exhibition registered by the user.

The current user location acquisition unit U1806 may acquire the current location information of the user via a positioning system of a terminal used by the user. After the current location information of the user is acquired, the location matching unit U1807 determines whether the user is in the exhibition registered by the user. Location information of the exhibition registered by the user may be inputted in advance when the user inputs the exhibition registration information, or may be obtained by a system through querying map information according to a name of the exhibition in the exhibition registration information inputted by the user. If the user is at the exhibition registered by the user, i.e., the current location of the user is within a location range of the exhibition registered by the user, this indicates that the user is currently attending the exhibition. The product location display unit U1808 displays the location of the product which the user currently browses or searches for in the exhibition. Displaying the location of the product in the exhibition refers to displaying the location of the product in the exhibition that the user is currently attending, and such displaying may include acquiring a layout of the exhibition and marking the location of the product in the layout. The layout may be pre-stored in the system or may be retrieved from a web-connected exhibition system. The location of the product in the exhibition may be obtained from the exhibition information corresponding to the product. When a user is visiting an exhibition, a location of a product in the exhibition is displayed to the user, to facilitate the user to find the product, and thus improve the attraction of the product to customers.

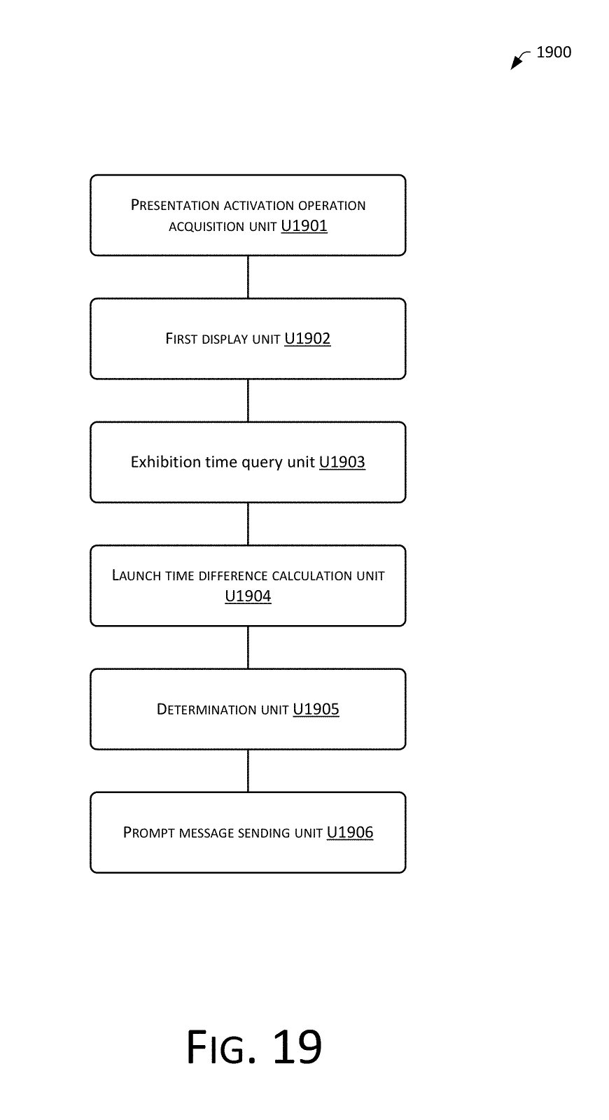

FIG. 19 is a structural diagram of another exhibition information presentation system 1900 according to an exemplary embodiment of the present disclosure. As shown in FIG. 19, the system 1900 may include a presentation activation operation acquisition unit U1901 configured to acquire an exhibition information presentation activation operation input by a user, the exhibition information presentation activation operation being associated with product information, and the product information being information about a product currently browsed or searched by the user; a first display unit U1902 configured to display exhibition information or an exhibition information link item corresponding to the product information at a preset first position according to the exhibition information presentation activation operation; an exhibition time query unit U1903 configured to query an exhibition time corresponding to product information collected or followed by the user; a launch time difference calculation unit U1904 configured to calculate a time difference between the exhibition time and a current time; a determination unit U1905 configured to determine whether the time difference is less than or equal to a preset threshold; and a prompt message sending unit U1906 configured to send a prompt message to the user if the time difference is less than or equal to the preset threshold, the prompt message being used for prompting the user with exhibition information corresponding to the collected or followed product information.

In implementations, the exhibition time query unit U1903 queries a corresponding exhibition time for product information collected or followed by the user in advance. The exhibition time may be acquired from exhibition information corresponding to the product information. The launch time difference calculation unit U1904 may then calculate a time difference between the exhibition time and a current time. If a determination result of the determination unit U1905 indicates that the time difference is less than or equal to the preset threshold, this indicates that the exhibition in which a product collected or followed by the user is going to participate is approaching. The prompt message sending unit U1906 may send a prompt message to the user to prompt the user with the exhibition information corresponding to the collected or followed product information, thus reminding the user to attend the related exhibition in time. In implementations, the preset threshold may be set according to an actual situation. In implementations, in response to determining that the time difference is less than or equal to the preset threshold, the prompt message may further be set to be sent at regular intervals.

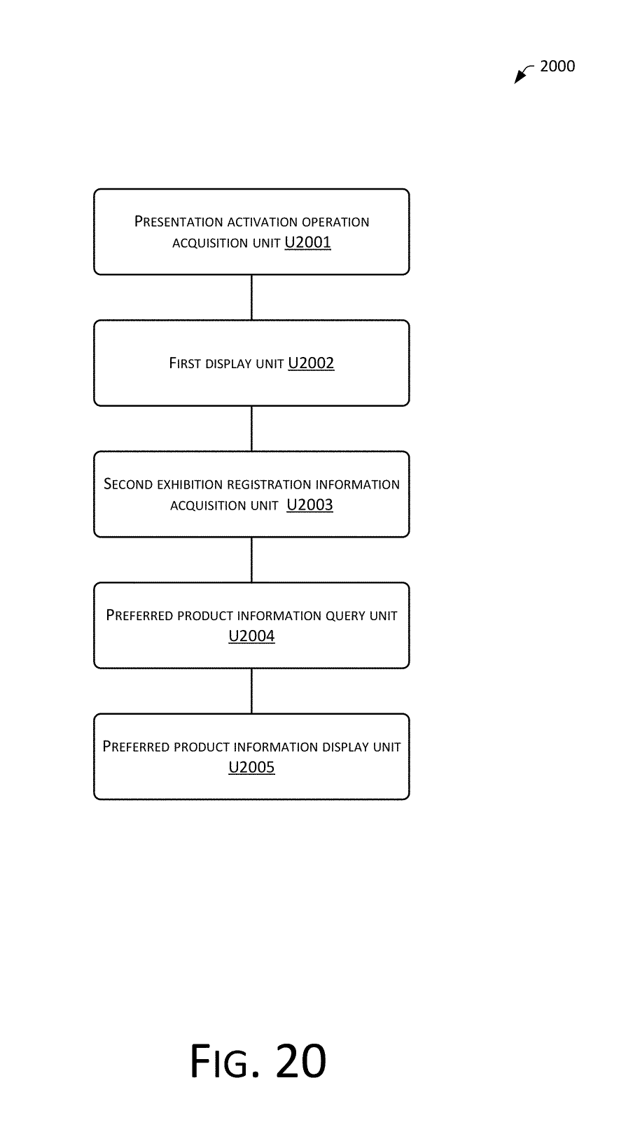

FIG. 20 is a structural diagram of another exhibition information presentation system 2000 according to an exemplary embodiment of the present disclosure. As shown in FIG. 20, the system 2000 may include a presentation activation operation acquisition unit U2001 configured to acquire an exhibition information presentation activation operation input by a user, the exhibition information presentation activation operation being associated with product information, and the product information being information about a product currently browsed or searched by the user; a first display unit U2002 configured to display exhibition information or an exhibition information link item corresponding to the product information at a preset first position according to the exhibition information presentation activation operation; a second exhibition registration information acquisition unit U2003 configured to acquire exhibition registration information of the user when the product information includes the information about the product currently searched by the user; a preferred product information query unit U2004 configured to query preferred product information, with exhibition information corresponding to the preferred product information being consistent with the exhibition registration information; and a preferred product information display unit U2005 configured to preferentially display the preferred product information on a product search result page.

In implementations, when the product information includes the information about the product currently searched by the user (i.e., when the user is searching for the product), the second exhibition registration information acquisition unit U2003 acquires exhibition registration information that is inputted by the user in advance. The preferred product information query unit U2004 queries exhibition information that is consistent with the exhibition registration information from among exhibition information corresponding to found product information, and obtains product information corresponding to the exhibition information that is consistent with the exhibition registration information, i.e., preferred product information. The preferred product information display unit U2005 may preferentially display the preferred product information that is found on the product search result page. In implementations, the exhibition information corresponding to the product information that is consistent with the exhibition registration information may include all exhibitions in the exhibition information corresponding to the product information being the same as all exhibitions in the exhibition registration information, some of the exhibitions in the exhibition information corresponding to the product information being the same as all of the exhibitions in the exhibition registration information, all of the exhibitions in the exhibition information corresponding to the product information being the same as some of the exhibitions in the exhibition registration information, or some of the exhibitions in the exhibition information corresponding to the product information being the same as some of the exhibitions in the exhibition registration information. In implementations, preferentially displaying may include arranging the preferred product information prior to other product information on the product search result page, highlighting the preferred product information, or a combination of arranging the preferred product information prior to the other product information and highlighting the preferred product information. Thus, the search efficiency of a product targeted by the user is improved and the promotion of the product is enhanced.

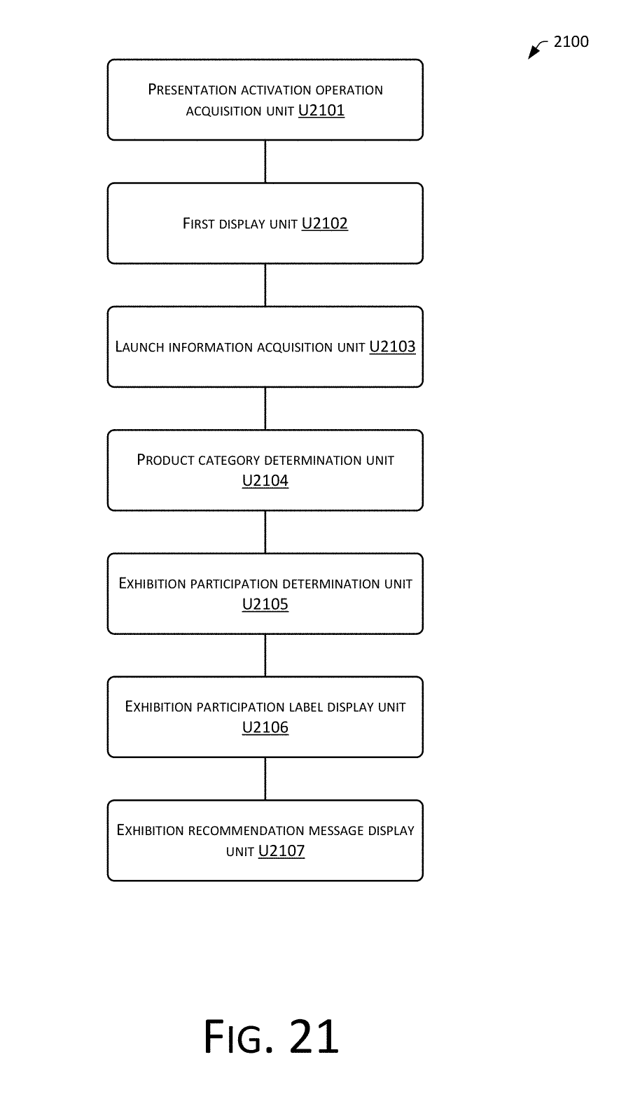

FIG. 21 is a structural diagram of another exhibition information presentation system 2100 according to a further exemplary embodiment of the present disclosure. As shown in FIG. 21, the system 2100 may include a presentation activation operation acquisition unit U2101 configured to acquire an exhibition information presentation activation operation input by a user, the exhibition information presentation activation operation being associated with product information, and the product information being information about a product currently browsed or searched by the user; a first display unit U2102 configured to display exhibition information or an exhibition information link item corresponding to the product information at a preset first position according to the exhibition information presentation activation operation; a launch information acquisition unit U2103 configured to acquire launch information of a new exhibition, the launch information including a product category exhibited; a product category determination unit U2104 configured to determine whether the product belongs to the product category based on the product information; an exhibition participation determination unit U2105 configured to determine whether the product has been registered with the new exhibition based on the exhibition information corresponding to the product information, if the product belongs to the product category; an exhibition participation label display unit U2106 configured to display a label indicating that the product has participated in the new exhibition if the product has been registered with the new exhibition; and an exhibition recommendation message display unit U2107 configured to display a new exhibition recommendation message if the product is not registered with the new exhibition.

In an application scenario, product information may include a product category. When setting or uploading information of a product, a merchant may set presentation information of the product which includes, for example, information about exhibitions that the product has already participated in, is currently participating in, and is going to participate in, and respective product categories of the exhibitions participated by the product. When presenting the product information, the exhibition information presentation system presents the exhibition information corresponding to the product information, and this is specific to the cases where the presentation information is already set up. The exhibition information presentation system 2100 may be coupled to exhibition data systems of exhibition institutions. As a promotion and service platform of an exhibition, the exhibition information system 2100 may passively acquire launch information of a new exhibition, i.e., the launch information acquisition unit U2103 may receive launch information of a new exhibition transmitted by an exhibition data system. Additionally or alternatively, the launch information acquisition unit U2103 may actively acquire launch information of the new exhibition from the exhibition data system according to a set time. The new exhibition may be an exhibition corresponding to launch information that is most recently received or acquired by the exhibition information presentation system 2100. Multiple exhibitions generally exist. Accordingly, for each exhibition, launch information of a respective exhibition most recently received by the exhibition information presentation system may be considered as a new exhibition of the exhibition with respect to historical exhibitions. Therefore, there may also be multiple new exhibitions. A launch time of a new exhibition may not necessarily be a time in the future. The new exhibition may be an ongoing exhibition or may be an upcoming exhibition.

The exhibited product category that is included in the launch information may further include information such as the place, the time, and the scale of the exhibition. After acquiring the launch information of the new exhibition, the launch information acquisition unit U2103 may also obtain the product category exhibited in the new exhibition. The product category determination unit U2104 may determine whether the product of the merchant belongs to the product category based on the product category in the product information that is already set or uploaded by the merchant. If the product belongs to the product category exhibited in the new exhibition, this indicates that the product can participate in the new exhibition. In this case, the exhibition participation determination unit U2105 may further determine whether the product has already participated in the new exhibition based on the exhibition information corresponding to the product information. The determination may include determining whether the new exhibition exists in the exhibition information. If the new exhibition exists, this indicates that the product has participated in the new exhibition. If the new exhibition does not exist, this indicates that the product does not participate in the new exhibition. Additionally or alternatively, the determination may include comparing information of the new exhibition with the exhibition information. If an exhibition having a same name as the new exhibition exists in the exhibition information, a launch time of the exhibition is further compared with that of the new exhibition. If the times are also the same, this indicates that the product has participated in the new exhibition. Otherwise, this indicates that the product does not participate in the new exhibition.

If the product has participated in the new exhibition, the exhibition participation label display unit U2106 may display a label indicating that the product has participated in the new exhibition on a page where the product information is located to remind the user to visit the exhibition. If the page where the product information is located is a separate product information page or a merchant product information page, a label indicating a single product or products of a merchant that have participated in the new exhibition is displayed on the page because the products of the merchant generally participate in a same exhibition. For the merchant product information page, a label indicating that the product has participated in the new exhibition may also be displayed at a presentation item setting position of a respective piece of information about each product that participates in the new exhibition. This is especially true when there are multiple new exhibitions and different products of the merchant participate in different new exhibitions. In these cases, corresponding to a piece of information about each product participating in a new exhibition, a label indicating that the respective product has participated in the new exhibition is displayed, so that related new exhibition participation information can be more clearly displayed to the user. On a page with multiple pieces of product information, such as a search result page, corresponding to a piece of information of each product, a label indicating that the respective product has participated in the new exhibition may also be displayed at a presentation item setting position of the piece of information of the product. If the product does not participate in the new exhibition, the exhibition recommendation message display unit U2107 may display a new exhibition recommendation message to remind the user or the merchant that the product may participate in the new exhibition. Because recommending new exhibitions that a product can participate is more valuable for merchants, a new exhibition recommendation message may be displayed only on a product information page displayed after login of a merchant account. If the product does not belong to the product category, this indicates that the product cannot participate in the new exhibition, and therefore the process is ended.

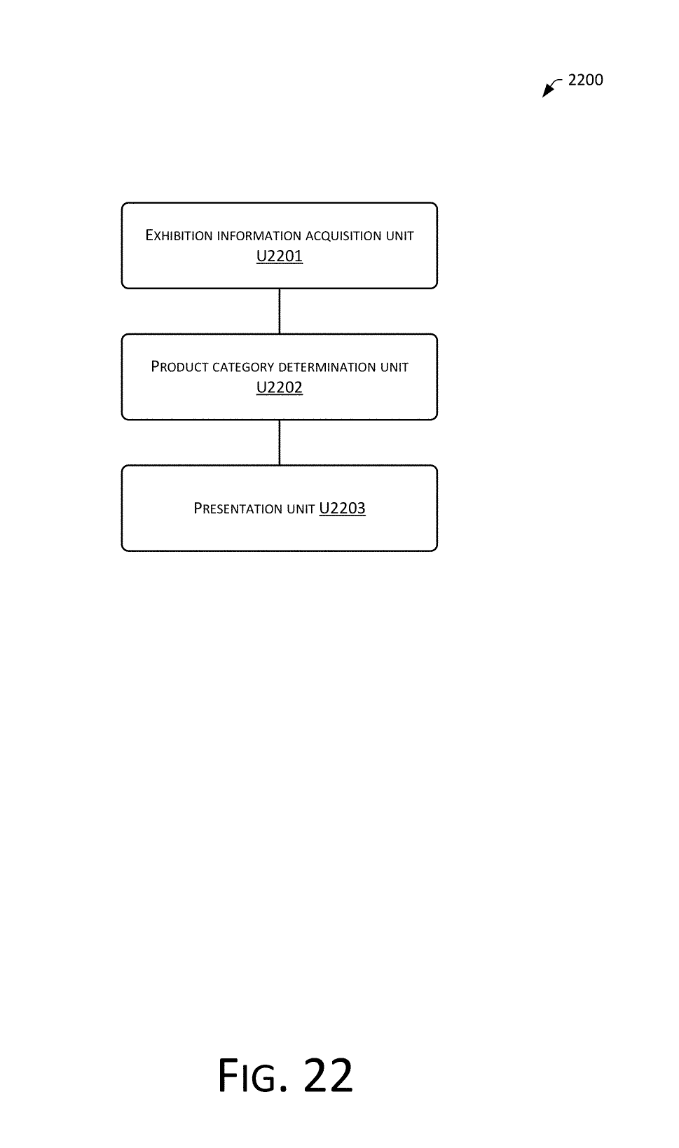

FIG. 22 is a structural diagram of another exhibition information presentation system 2200 according to an exemplary embodiment of the present disclosure. As shown in FIG. 22, the system 2200 may include an exhibition information acquisition unit U2201 configured to acquire exhibition information; a product category determination unit U2202 configured to determine a product category included in an exhibition based on the exhibition information; and a presentation unit U2203 configured to present related exhibition information on a page of a product belonging to the product category.

In implementations, the presentation unit U2203 may present entire exhibition information on the page of the product belonging to the product category, or present a portion of the exhibition information that corresponds to the product on the page of the product belonging to the product category if the exhibition information includes multiple product categories.

In implementations, a product platform or an e-commerce platform may define a protocol with an exhibition platform in advance. The exhibition information presentation system 2200 may read exhibition information, especially new exhibition information, from the exhibition platform according to the protocol in a regular basis or an irregular basis such as reading according to a presentation demand. Additionally or alternatively, when exhibition information stored in the exhibition platform is updated, the exhibition platform may send an update message to the exhibition information presentation system 2200, and the exhibition information presentation system 2200 may read new exhibition information from the exhibition platform after receiving the update message. Additionally or alternatively, the exhibition platform may regularly send exhibition information to the exhibition information presentation system 2200. Additionally or alternatively, when exhibition information in the exhibition platform is updated, the exhibition platform sends new exhibition information to the exhibition information presentation system 2200, and the exhibition information presentation system receives the exhibition information. The exhibition information includes product categor(ies) that is/are exhibited in an exhibition, and may further include information such as the time, the location, the booth distribution, the product introduction, the manufacturer introduction, and the marketing activities associated with the exhibition.

After the exhibition information acquisition unit U2201 acquires the exhibition information, the product category determination unit U2202 parses out a product category included in the exhibition according to the composition of the exhibition information. If a product category attribute is set in the exhibition information, the product category attribute can be directly read from the exhibition information, thereby determining the product category included in the exhibition. After the product category is determined, the presentation unit U2203 matches the product category with product categories in the product platform or e-commerce platform. If the product category does not exist in the product platform, the process is ended. If the product category exists, one or more products belonging to the product category are searched for in the product platform, and respective exhibition information is presented on page(s) of the one or more products. Presentation of the exhibition information may be a presentation of complete exhibition information. In implementations, for each product, a portion corresponding to the respective product from the exhibition information may be extracted, and the portion of exhibition information corresponding to the respective product may be presented on a page of the respective product. The presentation may include setting a presentation area on the page of the product in advance and presenting the exhibition information related to the product in the preset presentation area, or presenting the related exhibition information in a popup window on the page of the product or a new page.

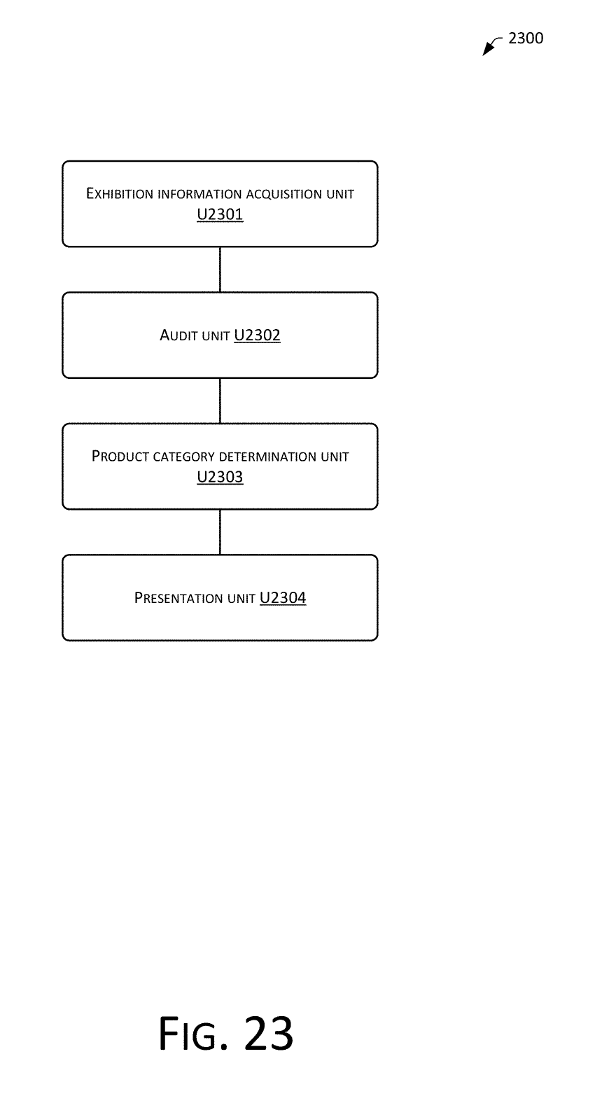

FIG. 23 is a structural diagram of another exhibition information presentation system 2300 according to an exemplary embodiment of the present disclosure. As shown in FIG. 23, the system 2300 may include an exhibition information acquisition unit U2301 configured to acquire exhibition information; an audit unit U2302 configured to audit the exhibition information after the exhibition information is acquired and before a product category related to an exhibition is determined according to the exhibition information; a product category determination unit U2303 configured to determine the product category included in the exhibition based on the exhibition information if the exhibition information passes the audit; and a presentation unit U2304 configured to present related exhibition information on a page of a product belonging to the product category.

After the exhibition information acquisition unit U2301 acquires exhibition information, the audit unit U2302 audits the exhibition information, for example, examining whether the exhibition information is illegal or whether the exhibition information has expired. If the exhibition information passes the audit, the product category determination unit U2303 determines a product category included in an exhibition according to the exhibition information. The auditing on the exhibition information helps to ensure the security of the system and the validity of program execution.

The exhibition information presentation system 2300 provided in the present embodiment of the present disclosure cooperates with an exhibition platform to automatically acquire exhibition information from the exhibition platform, determines a product category included in the exhibition information, and displays complete exhibition information or corresponding exhibition information of a product belonging to the product category on a page of the product, thus implementing automatic product-based and targeted promotion of exhibition information. This significantly improves the efficiency of promotion, and enhances the timeliness and the coverage rate of the promotion.

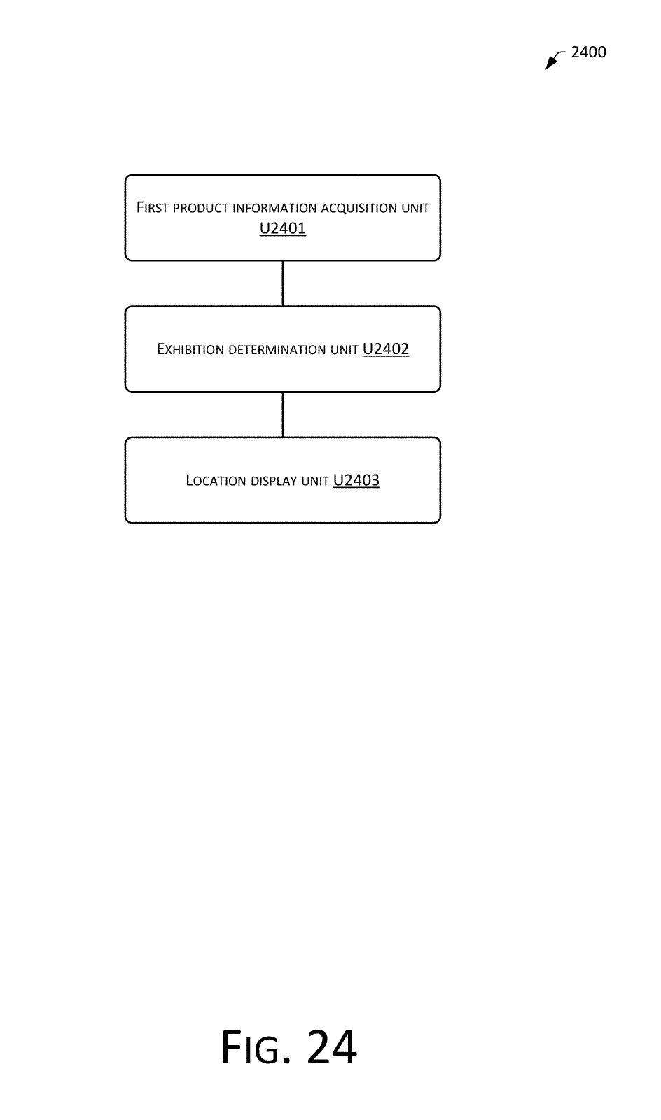

FIG. 24 is a structural diagram of an exhibition navigation apparatus 2400 according to an exemplary embodiment of the present disclosure. As shown in FIG. 24, the apparatus 2400 may include a first product information acquisition unit U2401 configured to acquire product information currently browsed by a user; an exhibition determination unit U2402 configured to determine whether a corresponding product is exhibited in an exhibition based on the product information; and a location display unit U2403 configured to display an exhibition map of the exhibition, and display an exhibition location of the product on the exhibition map if the product is exhibited in the exhibition.

The apparatus provided in the present embodiment may be applied to a product platform (or an Application (APP)), an e-commerce platform (or an APP), an exhibition platform (or an APP), or the like. When a user browses a product, the first product information acquisition unit U2401 may acquire corresponding product information. The exhibition determination unit U2402 may search and determine whether the product corresponding to the product information exists in pre-stored product-on-exhibition information (which is generally included in exhibition information). If the product exists, a determination can be made that the product is or will be shown in certain exhibition(s), and the exhibition(s) in which the product is or will be shown can be determined based on the product-on-exhibition information corresponding to the product. If the product does not exist, the process is ended.

If the product exists, the location display unit U2403 map display an exhibition map of the exhibition (i.e., an exhibition map of the exhibition to which the product belongs), finds location information of the product from product exhibition location information of the exhibition, and displays an exhibition location of the product on the exhibition map according to the location information. The exhibition location of the product may further be highlighted.

The apparatus 2400 provided in the present embodiment of the present disclosure displays a corresponding exhibition map and an exhibition location of a product in real time based on the product browsed by a user, thus achieving to view information about an exhibition when viewing information of a product. This facilitates the user to go to the exhibition and attend the exhibition.

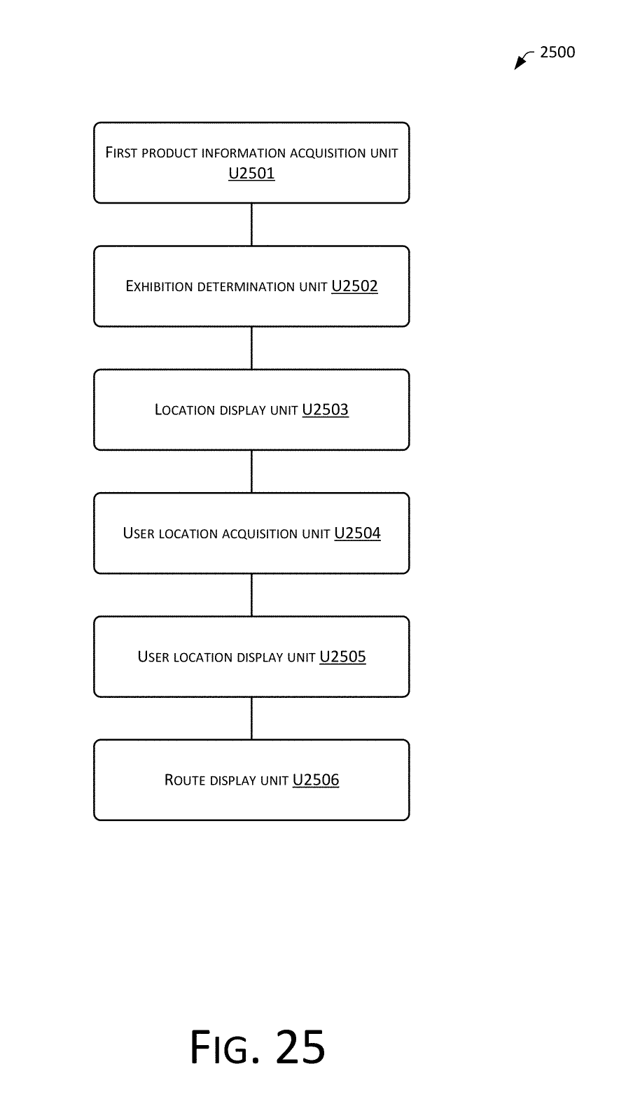

FIG. 25 is a structural diagram of another exhibition navigation apparatus 2500 according to an exemplary embodiment of the present disclosure. As shown in FIG. 25, the apparatus 2500 may include a first product information acquisition unit U2501 configured to acquire product information currently browsed by a user; an exhibition determination unit U2502 configured to determine whether a corresponding product is exhibited in an exhibition based on the product information; a location display unit U2503 configured to display an exhibition map of the exhibition, and display an exhibition location of the product on the exhibition map if the product is exhibited in the exhibition; a user location acquisition unit U2504 configured to acquire a current location of the user; a user location display unit U2505 configured to display the current location of the user on the exhibition map; a route display unit U2506 configured to display a route from the current location of the user to the exhibition location of the product.

In implementations, in addition to displaying the exhibition location of the product, the user location acquisition unit U2504 may further acquire a current location of the user through positioning information of a client terminal of the user, for example, GPS positioning information or base station positioning information of a mobile client terminal of the user, or an IP address of a PC of the user. The user location display unit U2505 may display the current location of the user on the exhibition map. If the exhibition map only includes a portion related to an exhibition while the current location of the user is not in the exhibition, the exhibition navigation system 2500 may display prompt information to indicate that the user is not currently in the exhibition, or display an error reporting message. If the exhibition map is in a full-map mode, for example, Amap mode, and the map of the exhibition is displayed in the Amap, the user location display unit U2505 may display the current location of the user on the full map. If the current location of the user is in the exhibition, the user location display unit U2505 may display the current location of the user on the exhibition map. In addition to displaying the current location of the user, the route display unit U2506 may further display a route from the current location of the user to the exhibition location of the product. In implementations, the route may be a line from the current location of the user to the exhibition location of the product. If the user is in the exhibition, the route may be a route including a passage from the current location of the user to the exhibition location of the product. If the current location of the user is on a full map, the route may be a geographical location navigation route, and the geographical location navigation route may be calculated using map software.

According to a product browsed by a user, the exhibition navigation apparatus 2500 provided in this embodiment displays a corresponding exhibition map and an exhibition location of the product in real time, and displays a location of the user as well as a route from the user to the exhibition location of the product, facilitating the user to go to the exhibition.

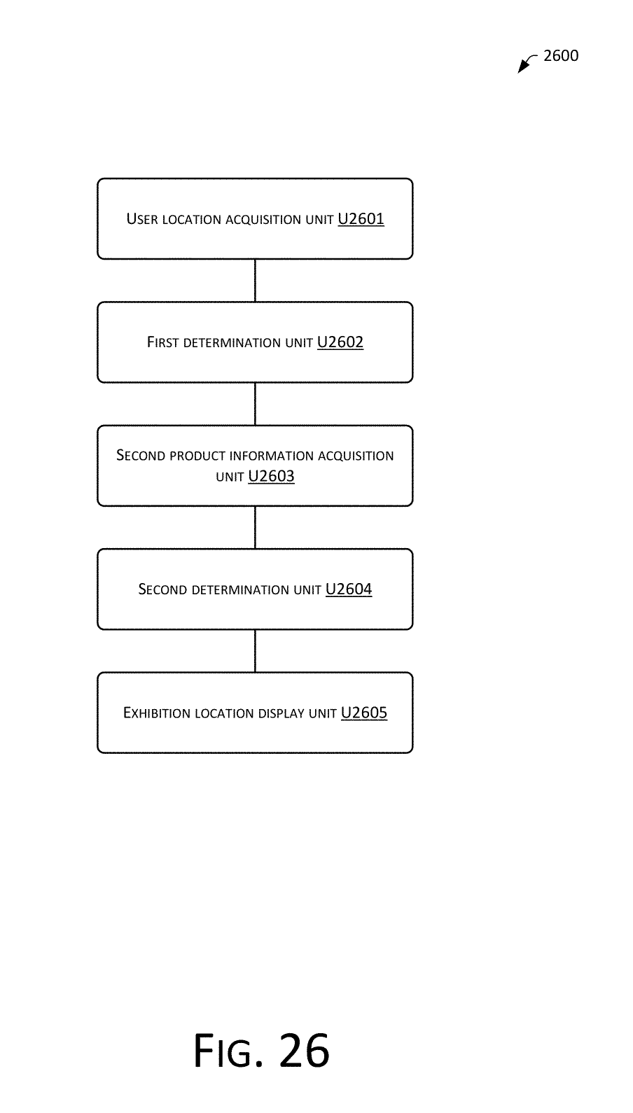

FIG. 26 is a structural diagram of another exhibition navigation apparatus 2600 according to an exemplary embodiment of the present disclosure. As shown in FIG. 26, the apparatus 2600 may include a user location acquisition unit U2601 configured to acquire a current location of a user; a first determination unit U2602 configured to compare the current location of the user with geographical locations of exhibitions to determine whether the user is in an exhibition; a second product information acquisition unit U2603 configured to acquire product information currently browsed by the user if the user is in an exhibition; a second determination unit U2604 configured to determine whether a corresponding product is exhibited in the exhibition where the user is located based on the product information; and an exhibition location display unit U2605 configured to display an exhibition location of the product on an exhibition map if the product is in the exhibition where the user is located.

The apparatus provided in the present embodiment may be applied to a product platform (or an Application (APP)), an e-commerce platform (or an APP), an exhibition platform (or an APP), or the like. Geographical locations of exhibitions are pre-stored. After the user location acquisition unit U2601 acquires a current location of a user, the first determination unit U2602 compares the current location of the user with the geographical locations of the exhibitions. If the current location of the user is the same as the geographical location of a certain exhibition, or is included in a geographical location range of the exhibition, the user is found to be in the exhibition. Otherwise, the user is currently not in any of the exhibitions, and the process may be ended. If the first determination unit U2602 determines that the user is in an exhibition, an exhibition map of the exhibition may be displayed. Alternatively, the exhibition map may not be displayed at this time. After determining that the user is in an exhibition, the second product information acquisition unit U2603 acquires product information currently browsed by the user, and the second determination unit U2604 compares the product information with product information of the exhibition where the user is located to determine whether a product corresponding to the product information is exhibited in the exhibition where the user is located. If the product information of the exhibition where the user is located includes the product information currently browsed by the user, a determination is made that the product currently browsed by the user is exhibited in the exhibition where the user is located. The exhibition location display unit U2605 finds an exhibition location of the product currently browsed by the user from among pre-stored product exhibition locations of the exhibition. If the exhibition map has been displayed previously, the exhibition location of the product is displayed on the exhibition map. If the exhibition map has not previously been displayed, the exhibition map is displayed, and the exhibition location of the product is displayed on the exhibition map. The exhibition location of the product may be highlighted to be easily viewed by the user.

The exhibition navigation apparatus 2600 provided in the present embodiment provides a user with real-time navigation to an exhibition location of a product when the user is at an exhibition, making it convenient for the user to rapidly position the product in the exhibition.

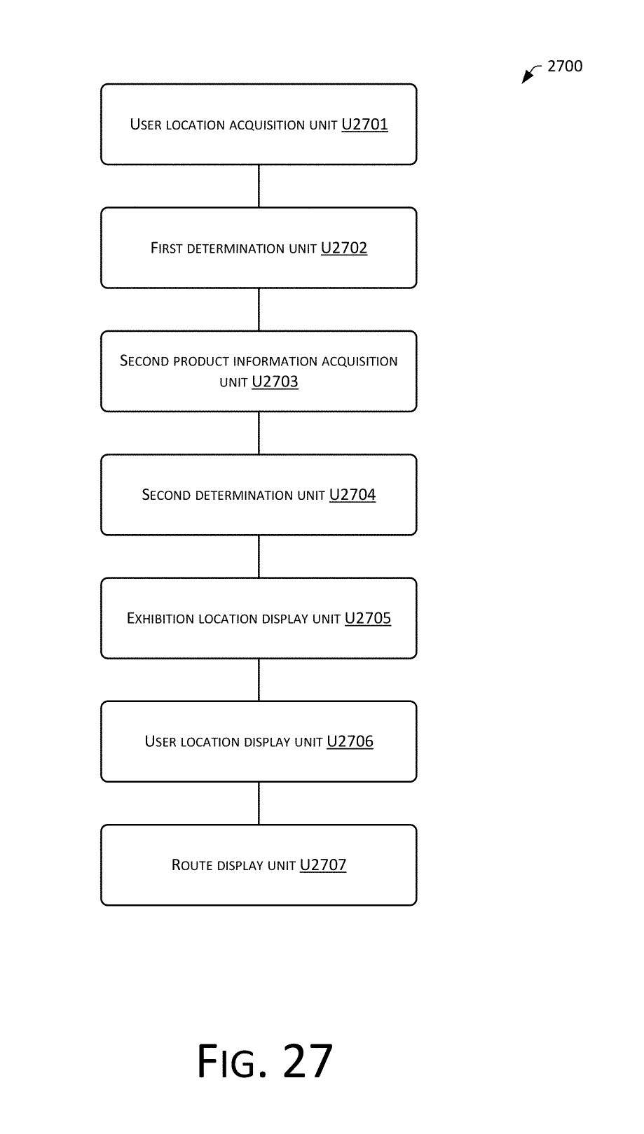

FIG. 27 is a structural diagram of another exhibition navigation apparatus 2700 according to an exemplary embodiment of the present disclosure. As shown in FIG. 27, the apparatus 2700 may include a user location acquisition unit U2701 configured to acquire a current location of a user; a first determination unit U2702 configured to compare the current location of the user with geographical locations of exhibitions to determine whether the user is in an exhibition; a second product information acquisition unit U2703 configured to acquire product information currently browsed by the user if the user is in an exhibition; a second determination unit U2704 configured to determine whether a corresponding product is exhibited in the exhibition where the user is located based on the product information; an exhibition location display unit U2705 configured to display an exhibition location of the product on an exhibition map if the product is in the exhibition where the user is located; a user location display unit U2706 configured to display the current location of the user on the exhibition map; and a route display unit U2707 configured to display a route from the current location of the user to the exhibition location of the product.

In addition to displaying the exhibition location of the product, a current location of the user may also be displayed on the map by the user location display unit U2706. A route from the current location of the user to the exhibition location of the product may further be displayed on the map using the route display unit U2707 to improve the efficiency of viewing the exhibition by the user. In implementations, the route may be a line from the current location of the user to the exhibition location of the product, or a route including a path from the current location of the user to the exhibition location of the product.

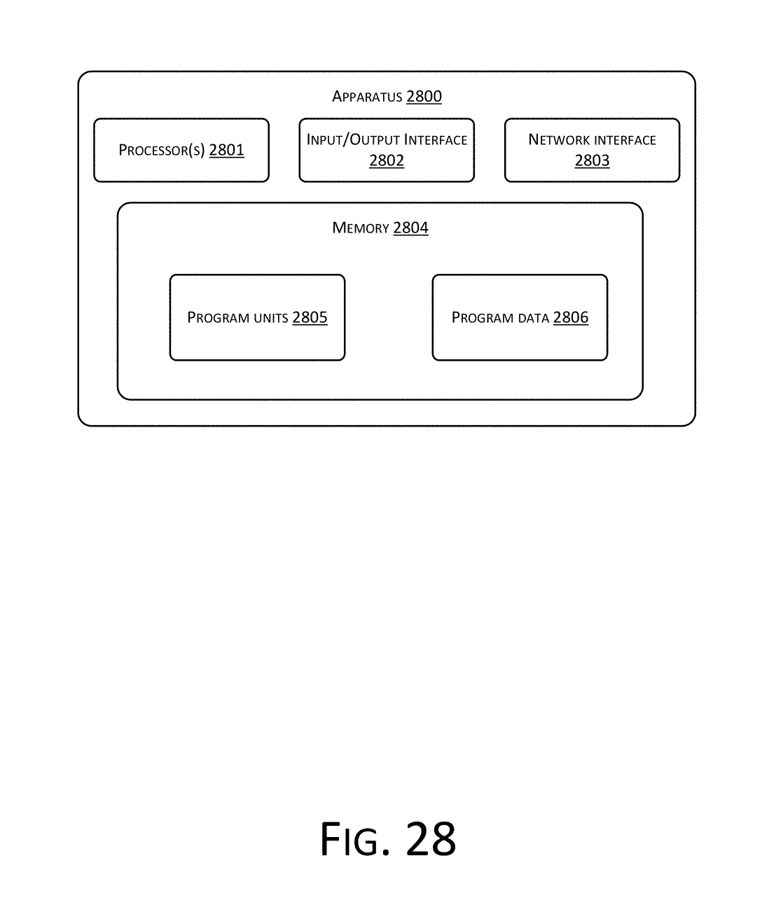

FIG. 28 is a structural diagram illustrating the example apparatus (or system) 2800 as shown in FIGS. 16-27 in more details. In implementations, the apparatus 2800 may include one or more computing devices. In implementations, the apparatus 2800 may be included in one or more computing devices. By way of example and not limitation, the apparatus 2800 may include one or more processors (CPU) 2801, an input/output interface 2802, a network interface 2803, and memory 2804 as shown in FIG. 28.

The memory 2804 may include a form of computer-readable media, e.g., a non-permanent storage device, random-access memory (RAM) and/or a nonvolatile internal storage, such as read-only memory (ROM) or flash RAM. The memory 2804 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves. For the ease of description, the system is divided into various types of units based on functions, and the units are described separately in the foregoing description. Apparently, the functions of various units may be implemented in one or more software and/or hardware components during an implementation of the present disclosure.

In implementations, the memory 2804 may include program units 2805 and program data 2806. The program units 2805 may include one or more of the foregoing units of the apparatuses and/or systems in FIGS. 16-27.

The embodiments in this specification are described in a progressive manner. Same or similar parts in the embodiments can be referenced to each other. Emphasis of each embodiment is different from other embodiments. Moreover, the description of the system or system embodiments is relatively simple because of their substantial similarities to the method embodiments. For related parts, reference may be made to the related portions of the description of the method embodiments. The system or system embodiments described above are merely exemplary, and the units described as separate components may or may not be physically separate. A component displayed as a unit may or may not be a physical unit, i.e., may be located at a single place, or distributed among multiple network units. Some or all of the modules may be selected according to an actual requirement to achieve the objective of the solutions of the embodiments. One of ordinary skill in the art can understand and implement the present disclosure without making any creative effort.

It should be noted that relational terms such as “first” and “second” herein are only used to differentiate one entity or operation from another entity or operation, but do not require or imply any actual relationship or reverse order between these entities or operations. Moreover, terms such as “include”, “comprise”, or any variants thereof are intended to cover a non-exclusive inclusion, such that a process, a method, a system, or a device that includes a series of elements includes not only such elements but also other elements not specified expressly, or may further include inherent elements of the process, method, system, or device. Without additional restrictions, an element limited by “include a/an . . . ” does not exclude other same elements existing in the process, method, system, or device that includes the element.

The above description is merely exemplary implementations of the present disclosure, to enable one skilled in the art to understand or implement the present disclosure. Various types of modifications to these embodiments would be obvious for one skilled in the art, and general principles defined herein may be implemented in other embodiments without departing from the spirit or scope of the present disclosure. Therefore, the present disclosure will not be limited by these embodiments shown herein, but needs to meet the broadest scope that is consistent with the principles and novel features disclosed herein.

1. A method implemented by one or more computing device, the method comprising:
acquiring an exhibition information presentation activation operation inputted by a first user, the exhibition information presentation activation operation being associated with product information, and the product information being information about a product browsed or searched by a second user; and
displaying exhibition information or an exhibition information link corresponding to the product information at a preset position according to the exhibition information presentation activation operation.

2. The method of claim 1, further comprising:
acquiring exhibition registration information of the second user;
determining whether an exhibition registered by the second user in the exhibition registration information matches an exhibition in the exhibition information corresponding to the product information based at least in part on the exhibition registration information; and
displaying a prompt dialog box in response to determining that the exhibition registered by the second user matches the exhibition in the exhibition information corresponding to the product information.

3. The method of claim 2, further comprising:
acquiring current location information of the second user;
determining whether the second user is currently at the exhibition registered by the second user based at least in part on the current location information; and
displaying a location of the product in the exhibition in response to determining that the second user is currently at the exhibition registered by the second user.

4. The method of claim 1, further comprising:
querying an exhibition time corresponding to product information collected or followed by the second user;
calculating a time difference between the exhibition time and a current time;
determining whether the time difference is less than or equal to a preset threshold; and
sending a prompt message to the second user in response to determining that the time difference is less than or equal to the preset threshold, the prompt message being used for prompting the second user with corresponding exhibition information of the collected or followed product information.

5. The method of claim 1, further comprising:
acquiring exhibition registration information of the second user;
querying preferred product information, wherein exhibition information corresponding to the preferred product information at least partially matches the exhibition registration information; and
displaying the preferred product information at top of a product search result page.

6. The method of claim 1, further comprising:
acquiring launch information of a new exhibition, the launch information comprising a product category that is shown in the new exhibition;
determining whether the product belongs to the product category based at least in part on the product information;
determining whether the product is participated in the new exhibition, in response to determining that the product belongs to the product category; and
displaying a label indicating that the product is participated in the new exhibition in response to determining that the product is participated in the new exhibition

7. The method of claim 1, further comprising:
acquiring the exhibition information;
determining a product category of an exhibition included in the exhibition information; and
presenting related information of the exhibition on a page of one or more products belonging to the product category.

8. The method of claim 7, wherein: after acquiring the exhibition information and before determining the product category of the exhibition, the method further comprises:
auditing the exhibition information; and
determining the product category of the exhibition included in the exhibition information, if the exhibition information passes the auditing.

9. The method of claim 7, wherein presenting the related information of the exhibition comprises presenting a portion of the exhibition information that corresponds to the one or more products on the page of the one or more products belonging to the product category if the exhibition information includes multiple product categories.

10. The method of claim 1, further comprising:
determining whether the product browsed or searched by the second user is exhibited in an exhibition included in the exhibition information; and
displaying an exhibition map of the exhibition and displaying an exhibition location of the product on the exhibition map in response to determining that the product is exhibited in the exhibition.

11. The method of claim 10, further comprising:
acquiring a current location of the second user;
displaying the current location of the second user on the exhibition map; and
displaying a route from the current location of the second user to the exhibition location of the product.

12. The method of claim 1, further comprising:
acquiring a current location of the second user;
comparing the current location of the second user with geographical locations of individual exhibitions included in the exhibition information to determine whether the second user is located in an exhibition;
acquiring the information of the product browsed by the second user in response to determining that the second user is located in the exhibition.

13. The method of claim 12, further comprising:
determining whether the product is exhibited in the exhibition where the second user is located; and
displaying an exhibition location of the product on an exhibition map if the product is exhibited in the exhibition where the second user is located.

14. The method of claim 12, further comprising:
displaying the current location of the second user on the exhibition map; and
displaying a route from the current location of the second user to the exhibition location of the product.

15. A system comprising:
one or more processors;
memory;
a presentation activation operation acquisition unit stored in the memory and executable by the one or more processors to acquire an exhibition information presentation activation operation inputted by a first user, the exhibition information presentation activation operation being associated with product information, and the product information being information about a product browsed or searched by a second user; and
a first display unit configured to display exhibition information or an exhibition information link corresponding to the product information according to the exhibition information presentation activation operation at a preset position.

16. The system of claim 15, further comprising:
a first exhibition registration information acquisition unit configured to acquire exhibition registration information of the second user;
an exhibition information matching unit configured to determine whether an exhibition registered by the second user in the exhibition registration information matches an exhibition in the exhibition information corresponding to the product information based on at least in part on the exhibition registration information; and
a prompt display unit configured to display a prompt dialog box in response to determining that the exhibition registered by the second user matches the exhibition information corresponding to the product information.

17. The system of claim 16, further comprising:
a current user location acquisition unit configured to acquire current location information of the second user;
a location matching unit configured to determine whether the second user is currently at the exhibition registered by the second user based at least in part on the current location information; and
a product location display unit configured to display a location of the product in the exhibition in response to determining that the second user is currently at the exhibition registered by the second user.

18. The system of claim 15, further comprising:
a first product information acquisition unit configured to acquire the information of the product currently browsed or searched by the second user;
an exhibition determination unit configured to determine whether the product browsed or searched by the second user is exhibited in an exhibition included in the exhibition information; and
a location display unit configured to display an exhibition map of the exhibition, and display an exhibition location of the product on the exhibition map in response to determining that the product is exhibited in the exhibition.

19. The system of claim 18, further comprising:
a user location acquisition unit configured to acquire a current location of the second user;
a user location display unit configured to display the current location of the second user on the exhibition map; and
a route display unit configured to display a route from the current location of the second user to the exhibition location of the product.

20. One or more computer-readable media storing executable instructions that, when executed by one or more processors, cause the one or more processors to perform act comprising:
acquiring product information browsed or searched by a user;
determining whether a product corresponding to the product information is presented in an exhibition based on the product information;
displaying an exhibition map of the exhibition and displaying an exhibition location of the product on the exhibition map in response to determining that the product is presented in the exhibition;
acquiring a current location of the user;
displaying the current location of the user on the exhibition map; and
displaying a route from the current location of the user to the exhibition location of the product.
